(19) United States
(12) Patent Application Publication
(10) Pub. No.: US 2026/0339912 A1
(43) Pub. Date: Oct. 29, 2026

(54) GRAPH VECTOR INDEX ENCODING FOR DATA-STRUCTURES

(71) Applicant: Microsoft Technology Licensing, LLC, Redmond, WA (US)

(72) Inventors: Nitish UPRETI, Fremont, CA (US); Samer BOSHRA, Heath, TX (US); Amar SAGARE, Bengaluru (IN); Balachandar PERUMALSWAMY, Bothell, WA (US); Martin Andras CHISHOLM, Bellevue, WA (US); Harsha Vardhan SIMHADRI, Seattle, WA (US); Krishnan SUNDARAM, Bothell, WA (US); Hari Sudan SUNDAR, Sammamish, WA (US); Subramanyam PATTIPAKA, Bellevue, WA (US); James Vincent CODELLA, Stamford, CT (US); Tamara Grace HASS, Seattle, WA (US); Abhishek SAHU, Bengaluru (IN); Santosh KULKARNI, Bengaluru (IN); Nitesh DUDHEY, Bellevue, WA (US); Shivam ATRI, Seattle, WA (US); Prashant GUPTA, Bengaluru (IN)

(21) Appl. No.: 19/188,668

(22) Filed: Apr. 24, 2025

(51) Int. Cl. G06F 16/22; G06F 16/21

(52) U.S. Cl. CPC G06F 16/2237; G06F 16/212

(57) ABSTRACT

Systems, methods, devices, and computer readable storage media described herein provide techniques for encoding graph indexes. In an aspect, a request to store data in a dataset is received. A vector is determined based on the request and the vector is encoded into a prefix specifying a location of the vector in vector space. A first index key is generated from at least the prefix. The first index key is associated with a value of the vector in an index. In a further aspect, the index is a graph vector index. In another aspect, a second request to obtain data is received. A second index key is generated based on the second request. The second index key is utilized to locate the first index key in the index. The value of the data is returned as a response to the second request.

### BACKGROUND

A search index can be used to aid in fulfilling search queries. A search query is a data structure that relates data of a dataset with one another and facilitates locating data responsive to a search request. A graph vector index is a type of search index that has vertices coupled to one another by edges to show relationships between data. Existing graph vector indices tightly couple logical semantics with on-disk physical storage formats and semantics.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein are related to encoding graph index vectors for use in storing and searching for data. In an aspect, a first request to store a first vector in a dataset is received. The first vector is encoded into a first prefix specifying a location of the first vector in vector space. A first vector identifier is assigned to the first vector. A first index key is generated from the first prefix and the first vector identifier. The first index key is associated with a value of the first vector in an index corresponding to at least a portion of the first index key.

In a further aspect, a second request for vector data is received. A second index key is generated based at least on the second request. The second index key is used to locate the association between the first index key and the value of the first vector in the index. The value of the first vector is provided as a response to the second request.

In a further aspect, the index is a graph comprising a first vertex corresponding to the first vector, a second vertex corresponding to a second vector, and an edge connecting the first vertex to the second vertex, the edge indicating a dependency of the first vertex on the second vertex.

In a further aspect, using the second key to locate the association between the first index key and the value of the first vector comprises traversing the graph to locate the first vertex by: beginning at a root vertex of the graph; traversing to the second vertex by selecting a subsequent vertex based on a level of similarity between the subsequent vertex and the second index key satisfying a similarity threshold; and identifying the first vertex based at least on the edge.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for encoding vector indices on data structures, in accordance with an example embodiment.

FIG. 2 shows a block diagram of a system comprising the search graph generator and storage manager of FIG. 1.

FIG. 3A shows a flowchart of a process for storing data, in accordance with an example embodiment.

FIG. 3B shows a flowchart of a process for accessing data, in accordance with an example embodiment.

FIG. 4 shows a block diagram of a system comprising the vector encoder of FIG. 1.

FIG. 5 shows a flowchart of a process for determining a vector representative of data, in accordance with another example embodiment.

FIG. 6 shows a flowchart of a process for encoding a vector, in accordance with an example embodiment.

FIG. 7 shows a flowchart of a process for associating an index with a physical address, in accordance with an example embodiment.

FIG. 8 shows an example excerpt of a graph, in accordance with an example embodiment.

FIG. 9 shows a flowchart for utilizing an index to obtain data, in accordance with an example embodiment.

FIG. 10 shows a flowchart of a process for traversing a graph to identify a vertex, in accordance with an example embodiment.

FIG. 11A shows a flowchart of a process for indexing a quantized vector, in accordance with an example embodiment.

FIG. 11B shows a flowchart of a process for indexing list information, in accordance with an example embodiment.

FIG. 12 shows a flowchart of a process for accessing data based on a type of the data, in accordance with an example embodiment.

FIG. 13 shows a block diagram of a system for locating an association in an index, in accordance with an example embodiment.

FIG. 14 shows a flowchart of a process for locating an association in an index, in accordance with an example embodiment.

FIG. 15 shows a block diagram of an example computing environment in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Embodiments for Encoding Vector Indices on Data-Structures

Search systems handle queries for datasets in various ways. For instance, a search system can utilize various algorithms and techniques in order to respond to a query for data. An example search system utilizes a search index to aid in fulfilling search queries. A search index is a data structure that relates data of a dataset with one another and facilitates searching for data within the dataset. A graph vector index (also referred to as a “graph index” herein) is a type of search index that has vertices representing data objects within a dataset. Each vertex can correspond to a single or subgroup of data objects within the database. The graph index can further include neighbor data that specifies relationships between multiple vertices within the graph, e.g., vertices that are near each other in vector space or are otherwise associated or related with one another. Connections between vertices can be represented as “edges” in the graph index. An edge between two vertices can be randomly generated at the creation of the graph index, created during traversal of the graph index, or generated based on a rule or policy. For instance, an example graph index includes an edge between two vertices that have properties with the same values or with values that have a level of similarity that satisfies a threshold.

The graph index leverages input vector data from a search query, compressed vector data, and a graph representation to respond to search queries. For instance, in a k-Nearest Neighbor (k-N N) query, a search system navigates vertices of the graph index along a path until arriving at a point that corresponds to a value associated with a search query. The search system identifies the nearest neighbors to the point, where the nearest neighbors correspond to items from the dataset. The search system provides the items as a set of results for the search query.

Graph vector indices can be used for indexing various types of databases. For instance, a graph vector index can be used for indexing a relational database (e.g., a structured query language (SQL) database) or a non-relational database (e.g., a NoSQL database). A non-relational database is a database that stores and facilitates retrieval of data without requiring tabular relations used in relational databases. For instance, a non-relational database can store data within a data structure without requiring a schema, enabling rapid scalability. Some implementations of non-relational database support SQL-like query languages or can sit alongside relational databases (e.g., as a “Not only SQL database”).

Existing graph vector indices tightly couple logical semantics (e.g., vector and graph data) with on-disk physical storage formats and semantics. However, this tight coupling poses several technical challenges in the context of non-relational databases. For example, in existing scenarios there is a risk of data-duplication of full vector data in non-relational storage and the graph index, such as when vector data is stored in a customer payload and duplicated into the graph vector index. This can place pressure on storage space and memory usage. Quantized vector data can also be duplicated between non-relational vector indices and graph vector indices in the system. For instance, if quantized vector data is stored in a flat index for facilitating scans for compressed vectors and duplicated in the graph vector index. Still further, management overheads such as compute resource usage, in-memory usage, and on-disk storage space usage in a schema free non-relational system can escalate with a large number of logical indices. For example, a non-relational database can store data for many (e.g., hundreds, thousands, tens of thousands, hundreds of thousands, or even greater) unique customers and/or tenants with an index per tenant. If a separate physical file level storage is used for each tenant/index, the complexity and overhead resource usage of the storage system increases. This can lead to difficulties in tenant onboarding and management. Furthermore, some tenants can be very small with respect to other tenants (such as a tenant that is a single user versus a tenant that is an organization with several thousand employees), leading to further inefficiencies in indices.

Embodiments of the present disclosure provide a framework for decoupling logical semantics from underlying physical storage semantics using a graph index. Decoupling the logical semantics from the underlying physical storage reduces the risk of data-duplication, as full vector data does not have to be stored in both the graph index and the underlying physical storage. Furthermore, multiple graph indexes can map to the same physical storage system. This enables a database provider to have different customers and/or tenants mapped to the same physical storage sub-system of a database system, reducing overhead and compute resources of the database system. Still further, decoupling logical semantics from physical semantics enables search systems to utilize efficient index operations based on logical semantics without having to conform to physical semantic restrictions or limitations.

To decouple logical semantics from the semantics of the underlying physical storage system, the graph index maps logical identifiers of vector data to corresponding address identifiers of physical addresses of where the vector data is stored. In this context, the logical identifiers are “keys” of the graph index and the address identifiers are corresponding “values.” By having the logical identifiers and address identifiers mapped to each other in the graph index, the semantics of the logical identifiers do not have to conform to the semantics of the address identifiers. In this context, the logical semantics are decoupled from the physical storage semantics, while enabling systems to lookup which physical addresses correspond to a logical identifier.

For instance, suppose data is to be stored in a database. In this example, a graph index generator can store the data in a dataset and utilize the graph index to map a logical identifier of the data to the address of the physical storage it is stored in. The graph index generator receives a request to store data in a dataset. In this example, data is a vector; however, in an alternative, the graph index generator determines a vector representative of the data. The graph index generator encodes the vector into a prefix that specifies a location of the vector in vector space and a type of the vector. The vector is assigned a vector identifier and an index key is generated based on the vector identifier and the prefix. The graph index generator associates the index key with a physical address in an index. For instance, the graph index generator can specify the index key as a “key” of a key/value pair in the index and specify the physical address as the “value” of the key/value pair. The physical address specifies a location in a physical storage (such as a storage server, a memory device, and/or the like). In an example, the graph index generator associates the index key with an identifier of the physical address. For instance, the identifier of the physical address can specify a persistent data-structure (such as a B-tree or a Bw-tree) that maintains data. The graph index generator causes the data to be stored at the physical address. By generating index keys and utilizing an index that associates the generated index keys with physical addresses data is stored in in this manner, embodiments described herein decouple logic graph vector index data from underlying physical storage semantics. In other words, requests for the data can reference the vector identifier of the vector and the graph index generator can automatically translate the vector identifier into an index key suitable for locating and returning the stored data.

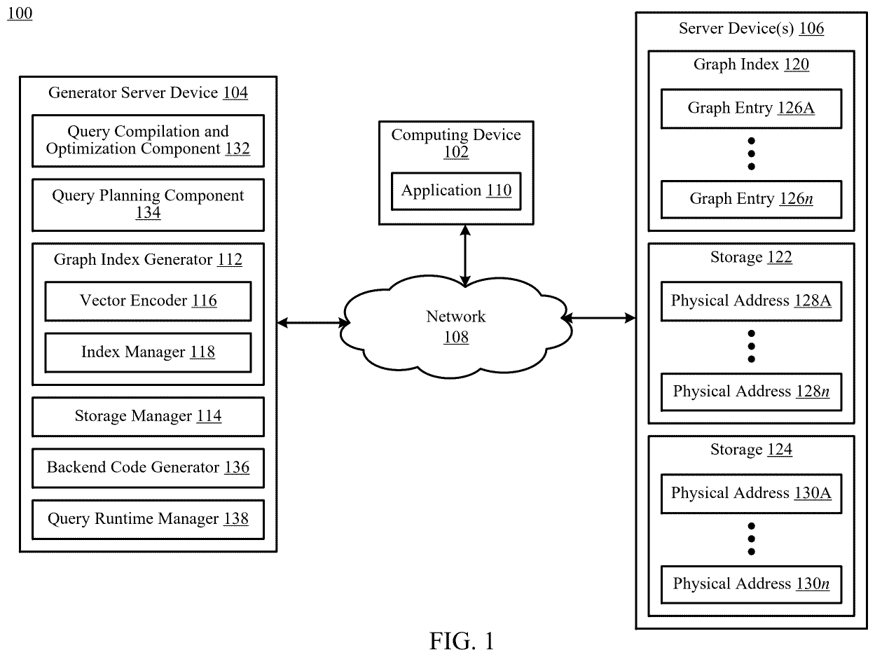

Embodiments can leverage a decoupled graph index in various ways. For instance, FIG. 1 shows a block diagram of a system 100 for encoding vector indices on data structures, in accordance with an example embodiment. As shown in FIG. 1, system 100 comprises a computing device 102, a generator server device 104, and one or more server devices 106 (“servers 106” herein). In an embodiment, computing device 102, generator server device 104, and servers 106 are communicatively coupled via a network 108. In examples, network 108 comprises one or more networks such as local area networks (LANs), wide area networks (WANs), enterprise networks, the Internet, etc. In examples, network 108 comprises one or more wired and/or wireless portions. The features of system 100 are described in detail as follows.

In examples, computing device 102 is any type of stationary or mobile processing device, including, but not limited to, a desktop computer, a server, a mobile or handheld device (such as a tablet, a personal data assistant (PDA), a smart phone, a laptop, etc.), an Internet-of-Things (IoT) device, etc. In accordance with an embodiment, computing device 102 is associated with a user (such as an individual user, a group of users, an organization, a family user, a customer user, an employee user, an admin user (such as a service team user, a developer user, a management user, etc.), etc.). Computing device 102 is configured to execute an application 110. Application 110 is any type of application for searching or querying for data. Examples of application 110 include, but are not limited to, search engine applications, data repository applications, data management applications, web browsers, and/or the like. In an implementation wherein application 110 is a web browser, a user of computing device 102 can interact with computing device 102 to cause the web browser to navigate to a web page for searching for data. Examples of such web pages include, but are not limited to, search engine websites, websites with local search tools, data management websites, and/or other types of websites that provide search capabilities. In accordance with an embodiment, application 110 enables a user to interface with generator server device 104 and/or one or more of servers 106.

Generator server device 104 and servers 106 are network-accessible servers or other types of computing devices. In accordance with an embodiment, one or more of generator server device 104 and servers 106 are incorporated in a network-accessible server set (such as a cloud-based environment, an enterprise network server set, and/or the like). In an embodiment, and as shown in FIG. 1, generator server device 104 and servers 106 are respective single servers. In an alternative example embodiment, generator server device 104 and/or servers 106 are implemented across multiple servers or computing devices (such as in a distributed server implementation) or integrated in a single server. Each of generator server device 104 and servers 106 are configured to execute services and/or store data. For instance, as shown in FIG. 1, generator server device 104 hosts a graph index generator 112, a storage manager 114, query compilation and optimization component 32, a query planning component 134, a backend code generator 136, and a query runtime manager 138 and servers 106 host a graph index 120, a storage 122, and a storage 124. In an embodiment, application 110 interfaces with graph index generator 112, storage manager 114, graph index 120, storage 122, and/or storage 124.

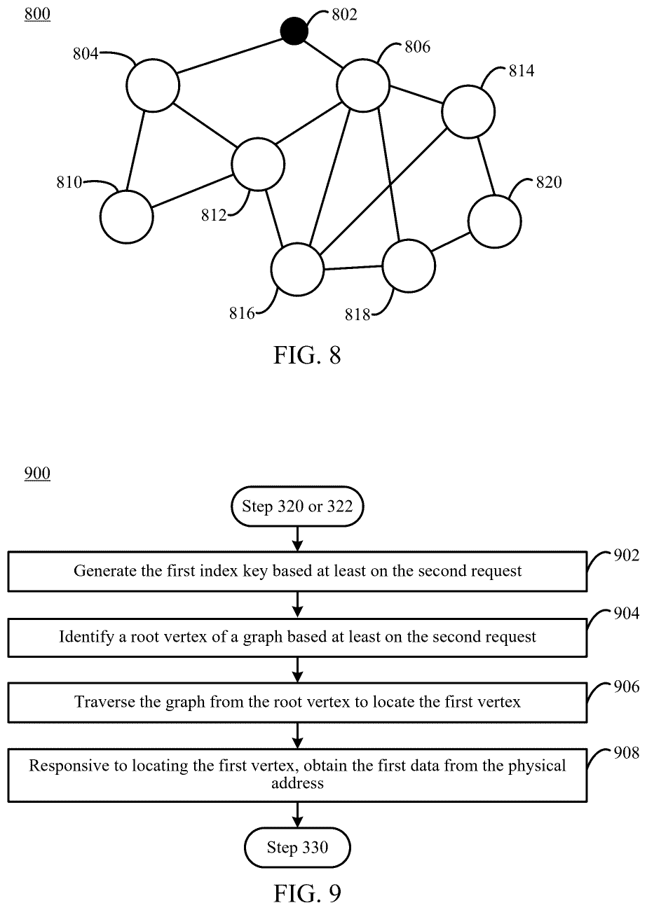

Graph index 120 is an index of graph entries. Graph index 120 is a data structure that can be used to facilitate searches for data. Graph index 120 has a plurality of vertices representing data objects within a dataset. Each vertex can correspond to a single or subgroup of data objects within the database. Vertices of graph index 120 are also referred to as “graph entries.” As shown in FIG. 1, graph index 120 comprises graph entries 126A-126n. In an embodiment, graph entries 126A-126n form a graph structure. An example of a graph structure is described with respect to FIG. 8, as well as elsewhere herein. In an embodiment, one or more of graph entries 126A-126n form a key-value store. In this context, graph index 120 can be accessed using a key of the key-value store to return a corresponding value.

Storages 122 and 124 are any types of physical storage devices, including but not limited to, storage disks, solid-state drives (SSDs), random access memory (RAM) devices, flash memory, digital video disks, and/or other types of physical/tangible hardware storage media. Storages 122 and 124 store data generated by and/or obtained by generator server device 104. For instance, in an embodiment, storages 122 and 124 store vector data (or other data) indexed in graph index 120. Data stored by storages 122 and 124 are stored in physical addresses. As shown in FIG. 1, storage 122 comprises physical addresses 128A-128n and storage 124 comprises physical addresses 130A-130n. In an embodiment, graph entries 126A-126n of graph index 120 map to respective addresses of physical addresses 128A-128n and/or 130A-130n.

As stated above, generator server device 104 comprises a graph index generator 112, a storage manager 114, query compilation and optimization component 32, a query planning component 134, a backend code generator 136, and a query runtime manager 138, each of which are computer-implemented services, components, or combinations of services and components. For example, graph index generator 112 is configured to receive search requests, generate graph indices, maintain graph indices, and perform other operations with respect to graph indices and searching utilizing graph indices. In an embodiment, graph index generator 112 generates and maintains graph index 120 (and/or other graph indices not shown in FIG. 1 for brevity).

As shown in FIG. 1, graph index generator 112 comprises a vector encoder 116 and an index manager 118. Vector encoder 116 comprises logic for receiving search queries, encoding vectors corresponding to the search queries, generating index keys corresponding to the vectors and/or other operations related to vectors and index keys. In accordance with an embodiment, vector encoder 116 determines a vector representative of data to be stored or queried for. The vector can either be the data or be generated to represent the data in vector space. Vector encoder 116 further encodes the vector by generating a prefix that specifies a location of the vector in vector space and a type of the vector. Vector encoder 116 can also assign a vector identifier (ID) to the vector. Vector encoder 116 further generates an index key from the prefix and vector ID. The index key can be used to retrieve a stored version of the vector or data, as described elsewhere herein.

Index manager 118 comprises logic for managing and accessing graph indices such as graph index 120. In accordance with an embodiment, index manager 118 updates or generates graph index 120 based on index keys generated by vector encoder 116 and corresponding vector data. In another aspect, index manager 118 utilizes an index key to obtain a corresponding value from graph index 120. In an aspect, index manager 118 associates index keys with corresponding values in graph index 120. In a further aspect, index manager 118 associates index keys with physical addresses that corresponding values are stored in.

Storage manager 114 is configured to manage storage of values in storage 122 and/or storage 124. Storage manager 114 comprises logic to interface with storages 122 and/or storage 124. While storage manager 114 is shown in FIG. 1 as separate from graph index generator 112, in some embodiments, it is integrated as a subservice or subcomponent of graph index generator 112. For instance, in an embodiment, index manager 118 and storage manager 114 are integrated as an index and storage manager. In another embodiment, storage manager 114 is integrated with storage 122. For instance, in an embodiment, storage manager 114 comprises logic for interpreting an address identifier obtained from graph index 120 into one or more of physical addresses 130A-130n.

Query compilation and optimization component 132 (also referred to as “component 132” herein) is configured to validate, compile, and optimize queries for data. In an embodiment, component 132 receives and compiles a query for data. For instance, component 132 receives a query and converts it into another data type (e.g., converting a stream of bytes into a sequence of tokens). Component 132 parses the query by applying rules (such as language grammar production rules) the query and generates a representation of the query. An example representation is as document object model. The representation of the query is further processed and verified to resolve issues such as semantic issues, internal or external symbol issues, or to apply transformations to produce an intermediate language query (“Query IL” herein). In an embodiment, the Query IL is further optimized using a Query IL optimizer.

Query planning component 134 is configured to analyze a Query IL output by component 132 and determine an execution strategy by selecting indexes and identifying operations that can be fully or partially pushed to index. In an aspect, query planning component 134 comprises a logical plan builder and optimizer and a physical plan builder and optimizer (not shown in FIG. 1 for brevity); however, other types of query planning components can be utilized. In an aspect, the logical plan builder builds a representation of a query focused on index utilization, known as a logical plan and outlines the high-level operations and transformations to retrieve data from storages 122 or 124. The logical plan can abstract the specifics of physical index implementations and index structures, instead focusing on the query's logical flow (such as operations like filtering, sorting, grouping, and aggregation). The logical plan optimizer enhances the plan by simplifying filter expressions and simulating application of set operators to minimize computational complexity and improve query performance. The physical plan builder translates the logical plan into a physical execution plan, selecting the physical operators and access paths based on efficiency, index availability, and query characteristics. In an embodiment, the physical plan builder is an implementation of graph index generator 112 and/or storage manager 114. The physical plan builder can generate multiple alternative execution plans, thereby enabling the system to autonomously select an optimal plan during optimization or index plan evaluation. The physical plan optimizer refines the execution strategy leveraging physical index statistics. It can reorder index scans based on cost estimations (e.g., compute resource estimations) and choose an execution path that has a lower cost and/or higher processing speed.

Backend code generator 136 is configured to generate a query execution service or virtual machine that executes a compiled query code against documents. In an embodiment, backend code generator 136 translates a query program (e.g., the Query IL) into a low-level language representation. The enumerable expressions of the representation are converted into a structured set of observables and observers. The observables and observers are translated into operation code (e.g., assembly language opcode) and observable callback initiations are mapped to corresponding method calls. In an implementation, the resulting code is executed within the flow of a virtual machine.

Query runtime manager 138 is configured to execute the code generated by backend code generator 136 against documents or other data received from storage manager 114. For instance, in an embodiment where storage manager 114 is caused to access documents or other data stored in storage(s) 122-124, query runtime manager 138 executes code generated by backend code generator 136 to execute aa query against the data.

Examples of component 132, query planning component 134, backend code generator 136, and query runtime manager 138 have been described herein for querying data and utilizing graph index generator 112 to generate and access graph index 120. In some embodiments, these components are implemented on devices separate from generator server device 104 (e.g., in a query processing and/or execution server). Furthermore, other implementations can leverage different components for query processing and/or execution.

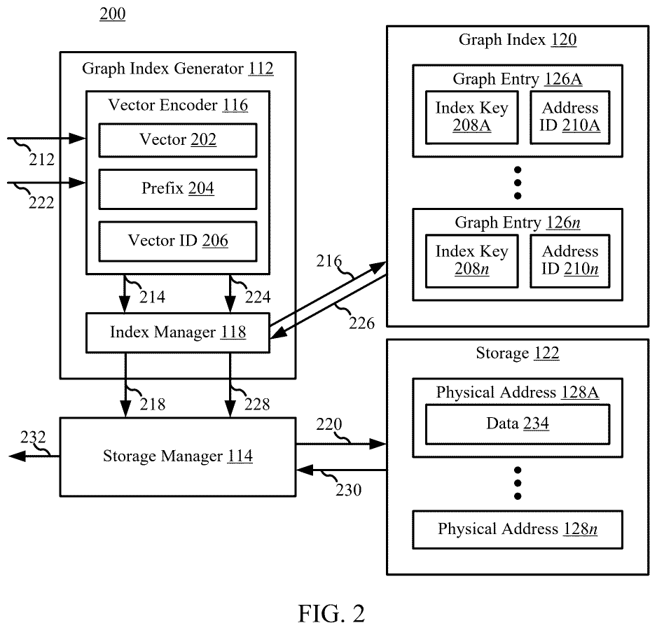

Thus, an example system for encoding vector indices on data structures has been described with respect to FIG. 1. In embodiments, graph index generator 112 of system 100 facilitates storing and accessing data utilizing graph index 120. Graph index generator 112 can be configured in various ways. For example, FIG. 2 shows a block diagram of a system 200 comprising graph index generator 112, storage manager 114, graph index 120, and storage 122 of FIG. 1. As also shown in FIG. 2, graph index generator 112 comprise vector encoder 116 and index manager 118, graph index 120 comprises graph entries 126A-126n, and storage comprises physical addresses 128A-128n, as described with respect to FIG. 1. As further shown in FIG. 2, vector encoder 116 comprises a vector 202, a prefix 204, and a vector ID 206. In implementations vector 202 is data received in a request to store data or a vector representative of the data to be stored, prefix 204 is a prefix generated for vector 202, and vector ID 206 is an identifier assigned to vector 202. As also shown in FIG. 2, graph entries 126A-126n comprise respective index keys 208A and 208n and address IDs 210A and 210n. In an implementation, index keys 208A and 208n are “keys” and address IDs 210A and 210n are corresponding “values” of their respective graph entries. Index keys 208A-208n are generated by vector encoder 116. Address IDs 210A-210n specify locations of respective physical addresses 128A-126n of storage 122. In an embodiment, address IDs 210A-210n are resource IDs of respective documents/files.

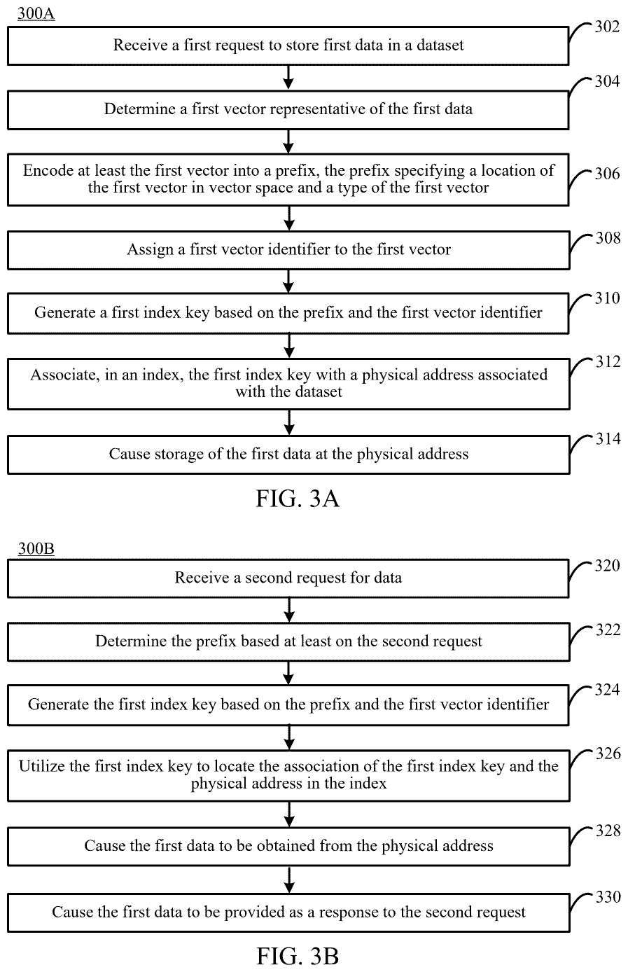

To better understand the operation of graph index generator 112 with respect to system 200, FIG. 2 is described with respect to FIGS. 3A and 3B. FIG. 3A shows a flowchart 300A of a process for storing data, in accordance with an example embodiment. FIG. 3B shows a flowchart 300B of a process for accessing data, in accordance with an example embodiment. In an embodiment, graph index generator 112 operates according to one or more steps of flowcharts 300A and/or 300B. Note not all steps of flowcharts 300A and 300B need be performed in all embodiments. Further structural and operational embodiments will be apparent to persons skilled in the relevant art(s) based on the following descriptions of FIGS. 2, 3A, and 3B.

With respect to FIG. 3A, flowchart 300A begins with step 302. In step 302, a first request to store first data in a dataset is received. For example, vector encoder 116 of FIG. 2 receives a request 212 to store data in a dataset. Depending on the implementation, request 212 comprises the data or identifies a location (such as a register) the data can be retrieved from. The data can be any type of data, such as a text file, a video file, an image file, metadata, a combination of value data and metadata, vector data, and/or the like. In an embodiment, request 212 comprises metadata that specifies a type of the data. For instance, in an example where the data is vector data, request 212 comprises metadata specifying the vector data is a full vector type, a compressed vector type (such as a quantized vector type), or a vector list type.

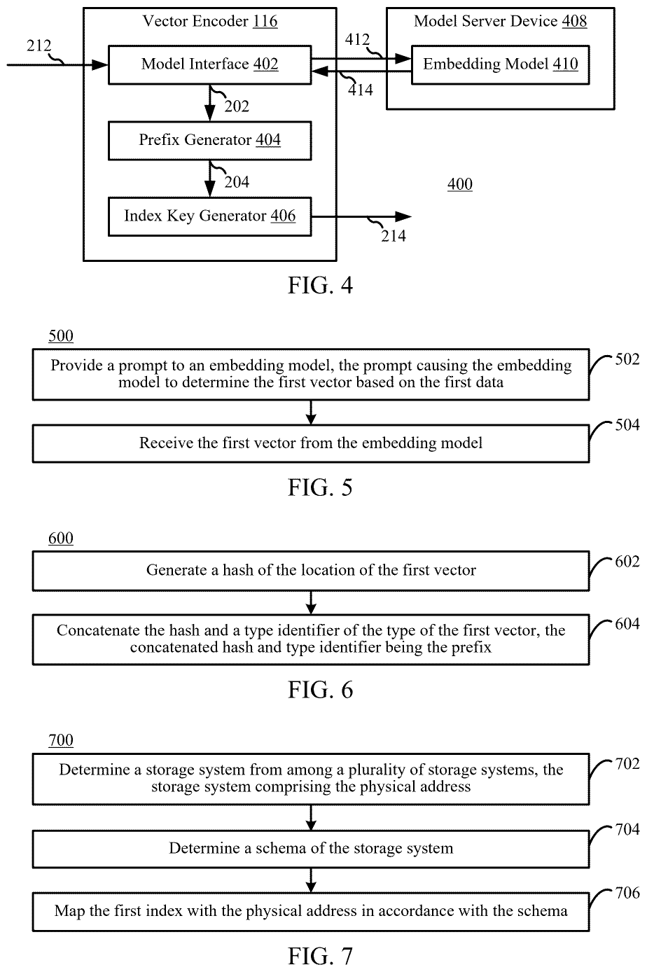

In step 304, a first vector representative of the first data is determined. For example, vector encoder 116 of FIG. 2 determines a vector 202 representative of the data to be stored. In an embodiment, the data to be stored is vector 202. In this context, request 212 comprises vector 202 or specifies a location vector encoder 116 can retrieve vector 202 from. Alternatively, and as described further with respect to FIGS. 4 and 5, vector encoder 116 generates vector 202 representative of the data to be stored. In an embodiment, vector 220 is a dense representation of semantic meaning of text or other data. For instance, vector 220 can be a floating-point number such that the distance between vector 220 and another vector in vector space is correlated to a semantic similarity between two corresponding inputs in their original format. In this context, vector 202 can be referred to as an “embedding.” Additional details regarding embeddings are described with respect to FIGS. 4 and 5, as well as elsewhere herein.

In step 306, the first vector is encoded into a prefix, the prefix specifying a location of the first vector in vector space and a type of the first vector. For example, vector encoder 116 encodes vector 202 into a prefix 204. In examples, prefix 204 specifies a location of vector 202 in vector space and a type of vector 202. In an example, prefix 204 is a concatenation of a hash of the location of vector 202 in vector space and the type of the vector. In a non-limiting example, the hash of the location is represented in a number of bytes (such as 15 bytes) and the type of the vector is represented in fewer bytes (such as 1 byte). Further details regarding encoding vector 202 into prefix 204 by generating a hash of the location and concatenating it with a type of vector 202 are described with respect to FIG. 6, as well as elsewhere herein.

In step 308, a first vector identifier is assigned to the first vector. For example, vector encoder 116 assigns a vector ID 206 to vector 202. Vector ID 206 uniquely identifies vector 202. In an embodiment, vector ID 206 is unique within graph index 120. In other embodiments, vector ID 206 is unique across multiple graph indices within system 200.

In step 310, a first index key is generated based on the prefix and the first vector identifier. For example, vector encoder 116 generates index key 214 based on prefix 204 and vector ID 206. In an embodiment, vector encoder 116 generates index key 214 by concatenating prefix 204 and vector ID 206. Index key 214 is a unique value that can be utilized to locate/find a value corresponding to vector 202 and/or a physical address the value is stored at. For instance, as described further with respect to flowchart 300B of FIG. 3B, as well as elsewhere herein, search requests for vector 202 (or data vector 202 corresponds to) can specify index key 214 to cause graph index generator 112 to retrieve vector 202 or corresponding data. Alternatively, as described elsewhere herein, a search request for vector 202 or corresponding data can specify information vector encoder 116 can utilize to generate or otherwise determine index key 214.

In step 312, the first index key is associated with a physical address in an index, the physical address associated with the dataset. For example, index manager 118 of FIG. 2 associates index key 214 and a physical address in graph index 120. As shown in FIG. 2, index manager 118 performs update operation 216 with respect to graph index 120 to cause a graph entry of graph index 120 to specify an association between index key 214 and a physical address the data is to be stored in. For instance, suppose update operation 216 causes graph entry 126A to be generated for graph index 120. In this context, update operation 216 causes graph entry 126A to specify index key 214 as index key 208A and associate index key 214 with address ID 210A of a physical address the data is to be stored at. For example, suppose address ID 210A uniquely identifies physical address 128A that data is to be stored at. In an embodiment, index manager 118 associates index key 208A and address ID 210A as a corresponding key and value of a key/value store. In this manner, a later search request can obtain address ID 210A utilizing index key 208A.

While FIG. 2 shows graph entry 126A specifying an association between index key 208A and address ID 210A, embodiments described herein are not so limited. For instance, in an alternative embodiment, graph entry 126A specifies an association between index key 208A and at least the value of vector 202. In this context, values for vectors can be directly obtained from graph index 120 using corresponding index keys.

In step 314, storage of the first data at the physical address is caused. For example, storage manager 114 of FIG. 2 stores the data requested to be stored in request 212 at the physical address associated with index key 208A. For instance, suppose address ID 210A uniquely identifies physical address 128A. In this context, index manager 118 provides index information 218 to storage manager 114 indicating data is to be stored at the address identified by address ID 210A. Storage manager 114 causes the data to be stored at physical address 128A as data 234 via storage signal 220.

Thus, an example of storing data using a graph index has been described with respect to system 200 of FIG. 2 and flowchart 300A of FIG. 3A. Storing data in this manner reduces the complexity of requesting applications. For instance, the requesting application is not required to specify a physical location of where the data is to be stored, nor is the requesting application required to know the underlying schema of the physical storage structure. Instead, graph index generator 112 handles translating the storage information into a logical component (the index key) and a physical location mapped to the logical component. By reducing the burden on requesting applications, graph index generator 112 can also facilitate usage of multiple types of storage systems for storing data. For instance, graph index generator 112 can selectively store full vector data in a first storage system specialized for storing full vector data, store compressed vector data in a second storage system specialized for storing compressed vector data, and store vector list data in a third storage system specialized for storing vector list data without requiring the requesting application to modify its interface to support multiple storage systems. This allows systems utilizing graph index generator 112 to increase, decrease, or otherwise modify their storage systems without requiring users (such as customers of a cloud system that implements graph index generator 112) to modify their front-end applications.

As described herein, graph index generator 112 can operate to utilize graph index 120 to access data in response to a search request. As stated above, flowchart 300B of FIG. 3B shows a process for utilizing graph index 120 to access data. Flowchart 300B begins with step 320. In step 320, a second request for data is received. For instance, vector encoder 116 receives request 222 for data. Suppose, in a non-limiting example, the data is for the same data stored responsive to request 212. In an embodiment, request 222 can be from the same application as request 212 or from a different application. Request 212 specifies an identifier that uniquely identifies the data to be accessed. For example, in the example where vector 202 is being requested, request 222 specifies vector ID 206.

In step 322, the prefix is determined based at least on the second request. For example, vector encoder 116 determines prefix 204 based at least on request 222. In an embodiment, request 222 comprises metadata or otherwise specifies a type of data to be retrieved. For instance, in an embodiment, request 222 specifies the data to be retrieved is full vector data, compressed vector data, or vector list data. In this context, vector encoder 116 determines prefix 206 based at least on a vector ID included in request 222 and the specified type of data. In an aspect, vector encoder 116 maintains a mapping between vector IDs+vector types and corresponding prefixes. In an alternative embodiment, request 222 is a search request for vectors semantically similar to a vector included in request 222. In this aspect, vector encoder 116 generates a “request prefix” for the vector included in request 222.

In step 324, the first index key is generated based on the prefix and the first vector identifier. For example, vector encoder 116 of FIG. 2 determines an index key 224 based on the prefix generated in step 322 and the vector ID included in request 222. In an example, index key 224 is identical to index key 214. Alternatively, index key 224 is semantically similar to index key 214. For instance, in an implementation where request 222 is a search request for vectors similar to a vector included therein, index key 224 is a key semantically similar to index key 214. As shown in FIG. 2, vector encoder 116 provides index key 224 to index manager 118.

In step 326, the first index key is utilized to locate the association of the first index key and the physical address in the index. For example, index manager 118 of FIG. 2 performs a search operation 226 using index key 224 to locate at least the association between index key 208A and address ID 210A. In an embodiment, search operation 226 utilizes index key 224 as a key in a key/value system to obtain values mapped in graph entries 126A-126n to index key 224. For instance, suppose index key 224 is identical to index key 208A. In this example, search operation 226 locates address ID 210A using index key 224 as the key of a key/value system. In an alternative embodiment, suppose index key 224 is semantically similar to index key 208A and search request 222 is a request for semantically similar vector data. In this alternative, search operation 226 searches graph entries 126A-126n to locate addresses associated with index keys semantically similar to index key 224, such as at least address ID 210A, as well as address IDs of any other semantically similar index keys.

In step 328, the first data is caused to be obtained from the physical address. For example, index manager 118 of FIG. 2 causes data to be obtained from physical addresses located in step 326. For instance, as shown in FIG. 2, index manager 118 provides index information 228 to storage manager 114 and causes storage manager 114 to obtain data stored in physical addresses located in step 326 via a retrieval operation 230. As an example, suppose address ID 210A was located in step 326 and address ID 210A uniquely identifies physical address 128A. In this example, retrieval operation 230 comprises accessing physical address 128A and obtaining data 234. In implementations where multiple address IDs are located, storage manager 114 performs multiple retrieval operations to retrieve data from each physical address identified by the address IDs. While FIG. 2 shows data 234 being obtained from the physical address by storage manager 114, in some embodiments, index manager 118 retrieves data 234.

In step 330, the first data is caused to be provided as a response to the second request. For example, index manager 118 causes data 234 (and any other requested data) to be provided as a response to request 222. In an aspect depicted in FIG. 2, index manager 118 causes storage manager 114 to provide data retrieved by retrieval operation 230 as a response 232 to request 222. In an alternative aspect, index manager 118 provides retrieved data as a response to request 222.

Thus, an example of access data using a graph index has been described with respect to system 200 of FIG. 2 and flowchart 300B of FIG. 3B. Utilizing a graph index in this manner reduces the complexity of front-end portions of search applications (such as application 110 of FIG. 1). For instance, the requesting application is not required to specify a physical location of where requested data is stored or to limit a storage system the data is stored in. Instead, graph index generator 112 translates a vector of a search request into an index key and utilizes the generated index key to locate vector values to return as a response. This reduces the burden on the requesting application while also facilitating usage of multiple types of storage systems. As described elsewhere herein, graph index generator 112 can selectively determine which vector values to return based on metadata and other information included in request 222 without having to modify a front-end interface of application 110. In some embodiments, graph index generator 112 can orchestrate multiple accesses of graph index 120 (e.g., in parallel).

In the examples described with respect to FIGS. 2-3B, the same graph index generator and storage manager are used to handle requests to store data and generate graph entries corresponding to the store data and to handle requests to access stored data based on existing graph entries. In an alternative embodiment, a separate graph index generator and/or storage manager are used for data storage requests (e.g., as described with respect to FIG. 3A) and data retrieval/query requests (e.g., as described with respect to FIG. 3B). In this context, the flow for the different graph index generators can be optimized to handle associated operations. For instance, an index manager that stores data in graph index 120 can be optimized for write-only operations whereas an index manager that accesses existing entries in graph index 120 can be optimized for read-only operations. Furthermore, a vector encode that encodes vectors for accessing data based on existing graph index entries does not need to include logic for generating/selecting a vector ID in an embodiment, as an existing vector and a received request already utilize the vector ID. By utilizing separate graph index generators in this manner, such embodiments are able to further reduce the time taken to respond to requests to store and/or access data, as fewer compute resources are expended in fulfilling the requests.

### III. Example Embodiments for Encoding Vectors and Generating Prefixes

Vector encoder 116 facilitates usage of graph index 120 by encoding vectors into prefixes. Prefixes enable graph index generator 112 (or components thereof) to index keys for use in locating graph entries of graph index 120 without requiring a requesting application to specify a physical location of vector values. In some cases, the data to be stored or accessed indicated in the request is a vector. Alternatively, vector encoder 116 generates a vector representative of the data to be stored or accessed. Vector encoder 116 in this alternative can be configured in various ways. For example, FIG. 4 shows a block diagram of a system 400 comprising vector encoder 116 of FIG. 1. As further shown in FIG. 4, vector encoder 116 comprises a model interface 402, a prefix generator 404, and an index key generator 406, each of which are implemented as subcomponents and/or subservices of vector encoder 116. As also shown in FIG. 4, system 400 comprises a model server device 408. Model server device 408 is further described as follows.

Model server device 408 is any type of server or other computing device. In an embodiment, model server device 408 is implemented in the same server infrastructure as generator server 104 and/or servers 106. As shown in FIG. 4, model server device 408 hosts an embedding model 410. Embedding model 410 is a model configured to generate embeddings for use in machine learning. The embeddings generated by embedding model 410 are information dense representation of semantic meaning of an input (e.g., a piece of text). For instance, in accordance with an embodiment, an embedding is a vector of floating-point numbers such that the distance between two embeddings in vector space is correlated with semantic similarity between two inputs in their original format (e.g., text format). As an example, if two texts are similar, their vector representations should also be similar. In this manner, embeddings generated by embedding model 136 provide representation of data usable by systems described herein for performing various functions associated with data represented by embeddings. For instance, generator server device 104 can utilize embeddings to represent data stored on behalf of users (such as a user associated with computing device 102), user accounts (such as a user account of application 110), services (such as application 110), and/or other devices (such as computing device 102).

To better understand the operation of vector encoder 116 of FIG. 4 with respect to system 400, FIG. 4 is described with respect to FIG. 5. FIG. 5 shows a flowchart 500 of a process for determining a vector representative of data, in accordance with another example embodiment. In an embodiment, vector encoder 116 operates according to one or more steps of flowchart 500. Note not all steps of flowchart 500 need be performed in all embodiments. Further structural and operational embodiments will be apparent to persons skilled in the relevant art(s) based on the following descriptions of FIGS. 4 and 5.

Flowchart 500 begins with step 502. In step 502, a prompt is provided to an embedding model, the prompt causing the embedding model to determine the first vector based on the first data. For example, model interface 402 of FIG. 4 receives request 212 and generates a prompt 412. Prompt 412 is a prompt to generate vector embeddings for data to be stored responsive to request 212. In an embodiment, prompt 412 comprises the data. As shown in FIG. 4, model interface 402 provides prompt 412 to embedding model 410, causing embedding model 410 to generate a response to prompt 412.

In step 504, the first vector is received from the embedding model. For example, model interface 402 of FIG. 4 receives a response 414 from embedding model comprising vector 202. In this context, vector 202 is information dense representation of data requested to be stored in request 212. As shown in FIG. 4, model interface 402 provides vector 202 to prefix generator 404. Prefix generator 404 operates to encode vector 202 into a prefix 204 such as in the manner described with respect to step 306 of flowchart 300A of FIG. 3A. Index key generator 406 operates to generate index key 214 based on prefix 204 such as in the manner described with respect to step 310 of flowchart 300A of FIG. 3A.

Vector encoder 116 can operate in various ways to encode a vector into a prefix, in embodiments. For instance, FIG. 6 shows a flowchart 600 of a process for encoding a vector, in accordance with an example embodiment. In an embodiment, vector encoder 116 of FIG. 1 or prefix generator 404 of FIG. 4 operates according to one or more steps of flowchart 600. Note not all steps of flowchart 600 need be performed in all embodiments. Further structural and operational embodiments will be apparent to persons skilled in the relevant art(s) based on the following description of FIG. 6.

Flowchart 600 begins with step 602. In step 602, a hash of the location of the first vector is generated. For example, vector encoder 116 of FIG. 2 generates a hash of the location of vector 202 in vector space. The hash is a fixed-length representation of the location. In an embodiment, vector encoder 116 utilizes a hashing algorithm to generate the hash of the location. Examples of hashing algorithms include, but are not limited to, message-digest algorithms (MDAs), secure hash algorithms (SHA algorithms), and/or other cryptographic hashing algorithms. By generating a fixed-length representation of the location of the vector, such embodiments of vector encoder 116 are able to generate uniform representations that can be evaluated for locating vectors and comparing locations of vectors.

In step 604, the hash and a type identifier of the type of the first vector are concatenated, the concatenated hash and type identifier being the prefix. For example, vector encoder 116 of FIG. 2 concatenates the hash generated in step 602 and a type identifier of vector 202 to generate prefix 204. In embodiments, the type identifier is included in request 212. Alternatively, vector encoder 116 evaluates the data of request 212 to determine its type. For instance, vector encoder 116 determines a the file type based on a file extension of the data or based on metadata for the data included in request 212. The resulting prefix can be leveraged in conjunction with a vector identifier to generate an index key in a similar manner as described with respect to step 310 of flowchart 300A of FIG. 3A.

### IV. Example Embodiments Supporting Multiple Storage Systems

As described herein, graph index generator 112 utilizes a graph index for accessing and storing data. In some implementations, graph index generator 112 enables use of multiple storage systems to store data without requiring requesting applications to know the schema of the underlying physical storage system. For example, with respect to FIG. 1, graph index generator 112 can determine whether to store data in storage 122 or storage 124 without requiring the requesting application 110 to specify which storage is to be accessed or without application 110 generating a request in accordance with a schema of the storage. Graph index generator 112 can operate in various ways to support multiple storage systems in this way. For instance, FIG. 7 shows a flowchart 700 of a process for associating an index with a physical address, in accordance with an example embodiment. In an embodiment, index manager 118 of FIG. 1 operates according to one or more steps of flowchart 700. In an embodiment, flowchart 700 is a further example of step 312 of flowchart 300A of FIG. 3A. Note not all steps of flowchart 700 need be performed in all embodiments. Further structural and operational embodiments will be apparent to persons skilled in the relevant art(s) based on the following description of FIG. 7.

Flowchart 700 begins with step 702. In step 702, a storage system is determined from among a plurality of storage systems, the storage system comprising the physical address. For example, index manager 118 of FIG. 2 determines storage 122 from a plurality of storage systems (such as from among storage systems 122 and 124 of FIG. 1). In an aspect, index manager 118 determines the storage system based on a type of vector 202 or other metadata associated with vector 202. For instance, suppose metadata of request 212 indicates a user account or application type of application 110. In this context, index manager 118 can evaluate the user account or application type along with a storage policy to automatically determine that data requested for storage in request 212 is to be stored in storage 122.

In step 704, a schema of the storage system is determined. For example, index manager 118 determines a schema of storage 122. The schema can specify how data is stored in storage 122. Examples of schema include, but are not limited to, keyspace and database schema. A keyspace is an object that specifies objects stored by storage 122. A keyspace is an abstraction of storage 122 without specifying a concrete structure. An example keyspace comprises one or more column families of columns of related data and/or super columns. In an example embodiment, a non-relational database uses a keyspace. A database schema specifies the structure of a relational database in a formal language. The database schema refers to the organization of data within the database.

In step 706, the first index key is mapped with the physical address in accordance with the schema. For example, index manager 118 maps index key 214 with address ID 210A in accordance with the schema determined in step 704. In this context, index manager 118 ensures the association in graph index 120 follows any necessary rules or formats of storage 122. For instance, the schema of storage 122 could specify a format that address IDs can follow. The schema can also indicate which physical addresses are available for storing data. In this context, index manager 118 selects an available physical address for storing the requested data.

### V. Example Embodiments of Graph Indices and Traversal Thereof

Embodiments of graph index generators have been described herein as utilizing graph indices to store and/or access data. A graph index can be constructed in various ways. For example, FIG. 8 shows an example excerpt of a graph 800, in accordance with an example embodiment. Graph 800 is an example of a graph index such as graph index 120 of FIG. 1. As shown in FIG. 8, graph 800 comprises a start vertex 802 (also referred to as “root vertex 802” herein) and a plurality of vertices 804-820 (also referred to as “vertices 804-820” herein). Start vertex 802 and vertices 804-820 are collectively referred to as “vertices 802-820” herein). In graph 800, relationships between vertices 802-820 are represented as “edges”. In embodiments, edges are generated randomly, based on similarities between vertices, or a combination thereof. In an example implementation, graph index generator 112 (or a component thereof) generates graph 800. For instance, in an embodiment, index manager 118 generates and maintains graph index 120.

To better understand graph index generator 112 utilizing graph 800, FIGS. 2 and 8 are described with respect to FIG. 9. FIG. 9 shows a flowchart 900 for utilizing an index to obtain data, in accordance with an example embodiment. In an embodiment, graph index generator 112 of FIG. 2 operates according to one or more steps of flowchart 900. Note not all steps of flowchart 900 need be performed in all embodiments. Further structural and operational embodiments will be apparent to persons skilled in the relevant art(s) based on the following description of FIG. 9 with respect to FIGS. 2 and 8.

Flowchart 900 begins with steps 320 or 322, as described with respect to FIG. 3B.

Flowchart continues to step 902. In step 902, the first index key is generated based at least on the second request. For example, vector encoder 116 generates index key 224 based at least on second request 222. In an example, vector encoder 116 generates index key 224 in a similar manner as described with respect to step 324 of flowchart 300B of FIG. 3B.

In step 904, a root vertex of a graph is identified based at least on the second request. For example, index manager 118 of FIG. 2 searches graph 800 of FIG. 8 utilizing index key 224 as a search key. In this example, index manager 118 begins with root vertex 802. Depending on the implementation root vertex 802 is a randomly selected root vertex, a root vertex with a higher semantic similarity to the vector corresponding to index key 224 than other root vertices of graph 800 (not shown in FIG. 8), or the only root vertex of graph 800. To better understand the operation of index manager 118 with respect to graph 800 in identifying the root vertex, the example is further described with Algorithm 1.

ALGORITHM 1
Search Algorithm

| | |
|---|---|
| 1 | Data: Graph G with start node s, query x_{q}, result size k, search list size L ≥ k |
| 2 | Result: [symbol] contains k-approx. NNs, and set of visited nodes V |
| 3 | begin |
| 4 | \| initialize sets [symbol] ← {s}, [symbol] ← 0, and V ← 0 |
| 5 | \| // [symbol] is the list of best L nodes, [symbol] is the set of nodes which have already been |
| | \| expanded from the list, V is the set of all visited nodes, e.g., inserted into |
| | \| the list |
| 6 | \| initialize hops ← 0 and cmps ← 0 |
| 7 | \| while [symbol] \ [symbol] ≠ 0 do |
| 8 | \| \| let p* ← arg minₚ [symbol] _{\} [symbol] \|\| xₚ − x_{q} \|\| |
| 9 | \| \| update [symbol] ← [symbol] ∪(Nₒᵤₜ(p*)\V) and [symbol] ← [symbol] ∪{p*} |
| 10 | \| \| if \| [symbol] \| > L then |
| 11 | \| \| \| update [symbol] to retain closest L points to x_{q} |
| 12 | \| _{L} update V ← V Nₒᵤₜ(p*) |
| 13 | _{L} return [closest k points from V;V] |

In Algorithm 1, G is graph 800, s is root vertex 802 and L represents the nodes of graph 800, vertices 804-820. [symbol] is a result of which vertex are the nearest neighbor to the requested vector, [symbol] is a set of vertices 802-820 that have already been expanded, and V is a set of which vertices 802-820 that have been visited. In line 4 of Algorithm 1 [symbol] , [symbol] , and V are initialized with root vertex 802 being the only vertex in [symbol] in this example. Traversal of graph 800 in accordance with Algorithm 1 is further describe. With respect to steps 906 and 908 as follows.

In step 906, the graph is traversed from the root vertex to locate the first vertex. For example, index manager 118 of FIG. 2 traverses graph 800 from root vertex 802 to locate a vertex that best corresponds to the vector requested in request 222. In an embodiment, index manager 118 greedily traverses graph 800 by searching for the vertex with the greatest semantic similarity to the requested vector. For instance, suppose vertex 812 is the target vertex. In this example, index manager 118 begins at root vertex 802 and determines whether vertex 804 or vertex 806 have a semantic similarity to the requested vector. Suppose index manager 118 determines vertex 806 has a higher level of semantic similarity. In this example, index manager 118 traverses to vertex 806 and determines which of vertex 812, 816, 818, or 814 is most semantically similar to the requested vector. Suppose vertex 812 has the highest semantic similarity, in which case index manager 118 traverses to vertex 812. Index manager 118 determines if vertex 812 or 810 have a higher semantic similarity to the search vector, as it has already determined vertices 804 and 816 are lower than 812. In this example, index manager 118 determines the semantic similarity of vertex 812 is higher than that of vertex 810. In an example embodiment, vertex 812 corresponds to graph entry 126A of FIG. 2.

With continued reference to Algorithm 1, lines 7-12 describe a process for greedily searching graph 800 for a nearest neighbor. In Algorithm 1, the processes searches for a nearest neighbor to query x_{q}, which, in the example described with respect to step 906 is the requested vector. The processes starts at line 8 and starting point s (e.g., vertex 802 in FIG. 8). In line 8, distances from q (the requested vector) to other vertexes with edges Nₒᵤₜ(s) connected to s (e.g., vertices 804 and 806 in FIG. 8) are computed and the smallest value represented of the nearest neighbor among vertices 804 and 806. In lines 9-12 describe updating [symbol] , [symbol] , and V based on vertices visited and the selected vertex. The process of lines 7-12 of Algorithm 1 continues until the closest neighbor to q cannot be improved.

In step 908, responsive to locating the first vertex, the first data is obtained from the physical address. For example, responsive to locating vertex 812, index manager 118 causes data to be obtained from a physical address corresponding to vertex 118. For instance, in continued reference to the example described with respect to step 906, index manager 118 determines the location of the requested data is identified by address ID 210A. Index manager 118 in this example causes data 234 to be obtained from physical address 128A, in a similar manner as described with respect to step 328 of flowchart 300B of FIG. 3B. For instance, with reference to Algorithm 1, the data is obtained from the physical address corresponding to the result. As further shown in FIG. 9, flowchart 900 concludes with step 330, as described with respect to FIG. 3B.

An example embodiment of traversing a graph to access data based on a nearest neighbor vertex to a request vector have been described with respect to FIGS. 8 and 9 and Algorithm 1. In some embodiments, greedy searching can be utilized to add vectors to graph 800 as well. For instance, as a non-limiting example, suppose graph 800 did not include vertex 816. In this example, graph index generator 112 of FIG. 2 can operate in a similar manner as described with respect to flowchart 300A of FIG. 3A to insert vertex 816 and its corresponding edges into graph 800. An example process graph index generator 112 can utilize to insert vertex 816 is described with respect to Algorithm 2 below.

ALGORITHM 2
Insert Algorithm

| | |
|---|---|
| 1 | Data: Graph G (P ,E) with start node s, new vector xₚ, parameter a > 1, out degree |
| | bound R, list size |
| 2 | Result: Graph G’(P’,E’) where P’ = P ∪ {p*} [symbol] |
| 3 | begin |
| 4 | \| initialize expanded nodes sets [symbol] ←0 |
| 5 | \| initialize candidate list [symbol] ←0 |
| 6 | \| [ [symbol] , [symbol] ,]← Algorithm 1(s, p, 1, L) |
| 7 | \| set Nₒᵤₜ(p) ← Prune(p, [symbol] ,a,R) |
| 8 | \| foreach j ϵ Nₒᵤₜ(p) do |
| 9 | \| \| if \|Nₒᵤₜ(p) ∪ {p}\| > R then |
| 10 | \| \| \| set Nₒᵤₜ(j) ←Prune(j, Nₒᵤₜ(j) ∪ {p}, a, R) |
| 11 | \| \| else |
| 12 | \| \| _{L} update Nₒᵤₜ(j) ← Nₒᵤₜ(j) ∪ {p} |
| 13 | \| _{L} |
| 14 | _{L} |

With reference to FIGS. 2, 3A, and 8, implementation of Algorithm 2 for inserting vertex 816 is described as follows. In lines 4 and 5, a candidate list of nodes and an expanded node set are initialized. At line 6, a call is placed to Algorithm 1 with arguments s, p, 1, and L. In this example, s is root vertex 802, p is vector 202 (i.e., the vector determined in step 304 of flowchart 300A), 1 is a number of k values for the intended result of the call to Algorithm 1 (in this example it is 1, but other implementations need not be so limited), and L is a list of vertices in graph 800, e.g., vertices 802-814 and 818-820 in this example. The call to Algorithm 1 greedily searches graph 800 for candidate nearest neighbors to vector 202. For instance, suppose the call to Algorithm 1 identifies vertices 806, 812, 814, and 818 as candidate nearest neighbors. In an example, the process ends here and graph 800 is updated to include vertex 816 and edges connecting vertex 816 to its nearest neighbors identified utilizing the call to Algorithm 1. However, in some embodiments, and as further described with respect to lines 7-12 of Algorithm 2, a pruning function “Prune” is used to reduce the candidates based on a threshold.

To better understand implementations of inserting algorithms such as Algorithm 2 utilizing pruning functions such as Prune, suppose the call to Algorithm 1 in line 6 also returned vertex 820 as a candidate nearest neighbor to vector 202. Prune prunes candidates based on a degree bound R. For instance, in an example, Prune removes edges between vertex 816 and candidate vertices that are have a likelihood to be reached by another neighbor of vertex 816 that satisfies a threshold. For instance, with respect to vertices 816-820, suppose vertex 820 can be reached from vertex 816 through vertex 818 in a distance that satisfies a threshold. In this context, Prune removes the edge (not shown in FIG. 8) between vertices 816 and 820. By removing edges in this manner, future searches utilizing graph 800 can be improved as there are fewer edges to consider at a given vertex. For instance, if a future search led to node 820 from node 814, the searching algorithm would consider nodes 820 and 818 in determining whether or not node 820 was an appropriate result or if node 818 had a higher level of similarity to the requesting vector, rather than also considering node 816. In this example, if node 816 were closer in semantic similarity to the request than node 820, the searching algorithm would traverse to node 818 and then to node 816.

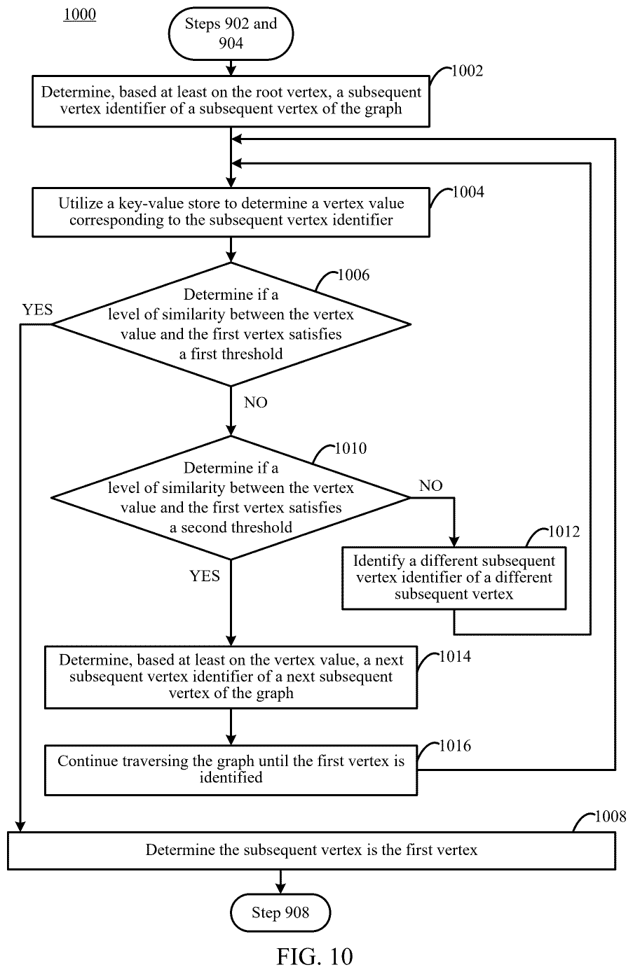

Index manager 118 can traverse graphs in various manners. In some embodiments, index manager 118 utilizes thresholds to determine if a semantic similarity is satisfied. Index manager 118 can operate to traverse graph 800 of FIG. 8 in this manner in various ways. For example, FIG. 10 shows a flowchart 1000 of a process for traversing a graph to identify a vertex, in accordance with an example embodiment. In an embodiment, graph index generator 112 of FIG. 2 operates according to one or more steps of flowchart 1000. Note not all steps of flowchart 1000 need be performed in all embodiments. Further structural and operational embodiments will be apparent to persons skilled in the relevant art(s) based on the following description of FIG. 10 with respect to FIGS. 2 and 8.

Flowchart 1000 begins with steps 902 and 904, as described with respect to flowchart 900 of FIG. 9. Flowchart 1000 continues with steps 1002-1016, which are further examples of step 906 as described with respect to flowchart 900 of FIG. 9. In step 1002, a subsequent identifier of a subsequent vertex of the graph is determined based at least on the root index. For example, with respect to FIG. 8, suppose index manager 118 of FIG. 2 determines vertex 804 is a subsequent vertex of graph 800 based at least on an edge connecting root vertex 802 to vertex 804. In situations where a vertex is connected to multiple vertices, index manager 118 can randomly select one of the edges to follow or selects them based on a predetermined order. For instance, suppose the edge connecting root vertex 802 to vertex 804 is the first in an order of edges of root vertex 802.

In step 1004, a key-value store is utilized to determine a vertex value corresponding to the subsequent vertex identifier. For example, index manager 118 of FIG. 2 utilizes a key/value store of graph index 120 to determine a value of vertex 804.

In step 1006, whether or not a level of similarity between the vertex value and the first vertex satisfies a first threshold is determined. Index manager 118 of FIG. 2 determines whether or not the value of vertex satisfies a first threshold. In this context, the first threshold represents an indication that the search for data is satisfies. A first threshold in a non-limiting example indicates a match between the vertex and the requested vector. For instance, in an embodiment where the requested data is represented as the same vector as data corresponding to vector 202, the first vertex is determined to satisfy the first threshold. Alternatively, the first threshold represents an indication that the vertex satisfies the threshold to a higher degree than other vertices in graph 800. If the level of similarity satisfies the first threshold, flowchart 1000 continues to step 1008. Otherwise, flow continues to step 1010. In the running example described herein, the value of vertex 804 does not satisfy the first threshold and flowchart 1000 continues to step 1008.

In step 1010, whether or not the level of similarity between the vertex value and the first index satisfies a second threshold is determined. For example, index manager 118 of FIG. 2 determines if the vertex value of vertex 804 satisfies a second threshold. This second threshold indicates the vertex is the next step in a path to the search result. In an embodiment, the second threshold represents a minimum degree of similarity a vertex is to have in order for index manager 118 to traverse to it instead of remaining at the present vertex. In an alternative embodiment, the second threshold represents having a degree of similarity higher than other vertices connected to the previous vertex. If the level of similarity satisfies the second threshold, flowchart 1000 continues to step 1014. Otherwise, flow continues to step 1012. In the running example described herein, the value of vertex 804 does not satisfy the second threshold and flowchart 1000 continues to step 1012.

In step 1012, a different subsequent vertex identifier of a different subsequent vertex is identified. For example, index manager 118 of FIG. 2 identifies a different subsequent vertex identifier of a different subsequent vertex. For instance, in the running example where index manager 118 is at root vertex 802 and has determined not to traverse to vertex 804, index manager 118 identifies vertex 806 connected to root vertex 802. Subsequent to step 1012, flowchart 1000 returns to step 1004, where the key-value store is used to determine a vertex value corresponding to the different subsequent vertex in a similar manner as described herein. For instance, in the running example where index manager 118 identifies vertex 806, index manager 118 repeats steps 1004-1010 with respect to vertex 806. In this example, suppose the level of similarity between vertex 806 and the requested vertex fails to satisfy the first threshold but satisfies the second threshold. In this context, index manager 118 traverses from root vertex 802 to vertex 806 and flowchart 1000 continues to step 1014.

In step 1014, a next subsequent vertex identifier of a next subsequent vertex of the graph is determined based at least on the vertex value. For example, index manager 118 of FIG. 2 in reference to the running example described herein determines at least a vertex identifier for vertex 812 based on a connection of vertex 812 to vertex 806. In some cases, index manager 118 identifies each vertex connected to vertex 806 by an edge.

In step 1016, traversal of the graph continues until the first vertex is identified. For instance, with continued reference to the running example described herein, index manager 118 repeats steps similar to those previously described with respect to root index 202 in order to determine which path (if any) to travel from vertex 806. For instance, suppose index manager 118 determined vertex 812 as the next subsequent vertex of graph 800. In this example, index manager 118 determines a vertex value of vertex 812 in a similar manner described with respect to step 1004 and determines if a level of similarity of the vertex value satisfies a first threshold as recited in step 1006. In this running example, the vertex value of vertex 812 satisfies the first threshold and flowchart 1000 continues to step 1008. In an alternative embodiment, prior to proceeding to step 1008, index manager 118 compares other values of vertices connected to vertex 806 by an edge to determine if their level of similarity to the requested vertex is higher than the level of similarity of vertex 812.

In step 1008, the subsequent vertex is determined to be the first vertex. For example, in a running example where vertex 812 is the vector requested in request 222, index manager 118 of FIG. 2 determines vertex 812 is the vector and Flowchart 1000 continues to step 908 of flowchart 900, as described with respect to FIG. 9. Alternatively, index manager 118 determines vertex 812 is a “best fit” or a “nearest neighbor” of the vector requested in request 222 and flowchart 1000 continues to step 908.

Thus, several example embodiments of traversing graphs have been described with respect to FIGS. 8-10. For instance, in an aspect, key-values are leveraged in order to identify nearest neighbors of search vectors. In embodiments, index manager 118 performs this search automatically and decoupled from the physical storage that stores the vector data. This allows index manager 118 to traverse a graph index that can support multiple or varied physical storage systems.

### VI. Example Embodiments for Storing and Accessing Multiple Types of Vector Data

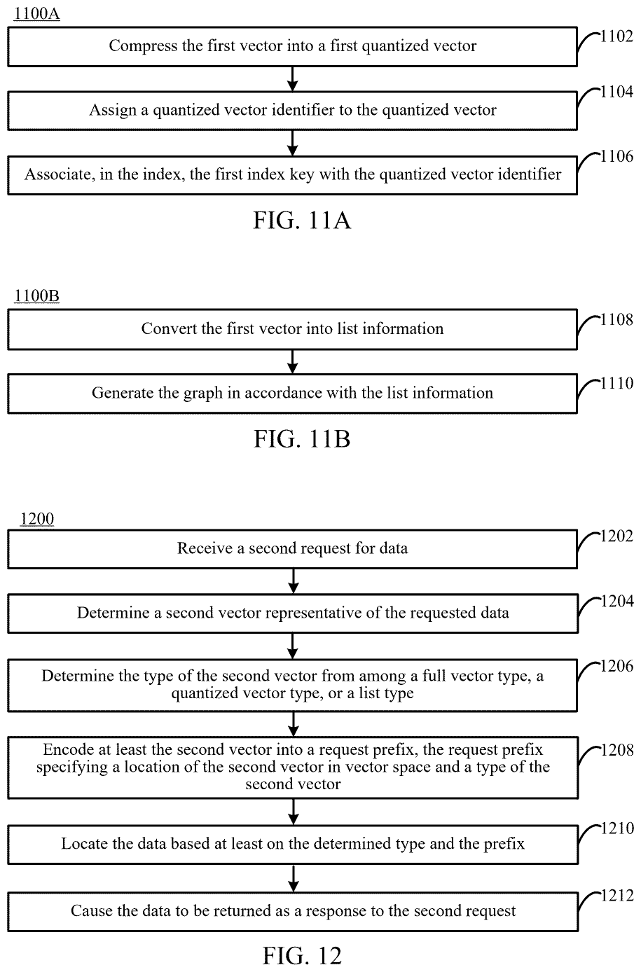

As described herein, graph index generators described herein can store and access data of various types. For instance, in embodiments, graph index generator 112 can store and access full vector data, compressed vector data (such as quantized vector data), and list vector data (such as adjacency list vector data). Graph index generator 112 of FIG. 2 can operate in various ways to support multiple data types. For instance, in some embodiments, graph index generator 112 can operate to store compressed vector data, such as quantized vector, in various ways. For example, FIG. 11A shows a flowchart 1100A of a process for indexing a quantized vector, in accordance with an example embodiment. In an embodiment, graph index generator 112 of FIG. 2 operates according to one or more steps of flowchart 1100A. Note not all steps of flowchart 1100A need be performed in all embodiments. Further structural and operational embodiments will be apparent to persons skilled in the relevant art(s) based on the following description of FIG. 11A with respect to FIG. 2.

Flowchart 1100A begins with step 1102. In step 1102, the first vector is compressed into a first quantized vector. For example, vector encoder 116 generates a quantized vector by compressing vector 202 utilizing a quantization technique. Example quantization techniques include, but are not limited to, scalar quantization and binary quantization. In scalar quantization, float values are compressed into narrower data types, e.g., a vector of 32-bit floats is compressed into a vector of 8 bit integers. In binary quantization, float values are compressed into respective binary bits (i.e., a 32-bit float is compressed into a single bit). By compressing vector data in this manner, such embodiments greatly reduce the storage space consumed by vectors. In an example embodiment, vector encoder 116 generates quantized data for the quantized vector, the quantized data specifying a vector length of the quantized vector and a value of the quantized vector. While examples described herein describe compressing vector data utilizing quantization techniques, other implementations can utilize other compression techniques such as path simplification, relative coordinate compaction, and/or the like.

In step 1104, a quantized vector identifier is assigned to the quantized vector. For example, vector encoder 116 assigns a quantized vector ID to the quantized vector in a similar manner as vector ID 206 was assigned to vector 202. In an example the quantized vector ID is identical to vector ID 206. In this context, a term type included in the prefix of the corresponding index key is utilized to differentiate where the quantized vector is stored from where vector 206 is stored. In an alternative embodiment, the quantized vector ID is a modified version of vector ID 206 that indicates the quantized vector is a quantized type. For instance, in an embodiment, the quantized vector ID is vector ID 206 with a type identifier appended thereto.

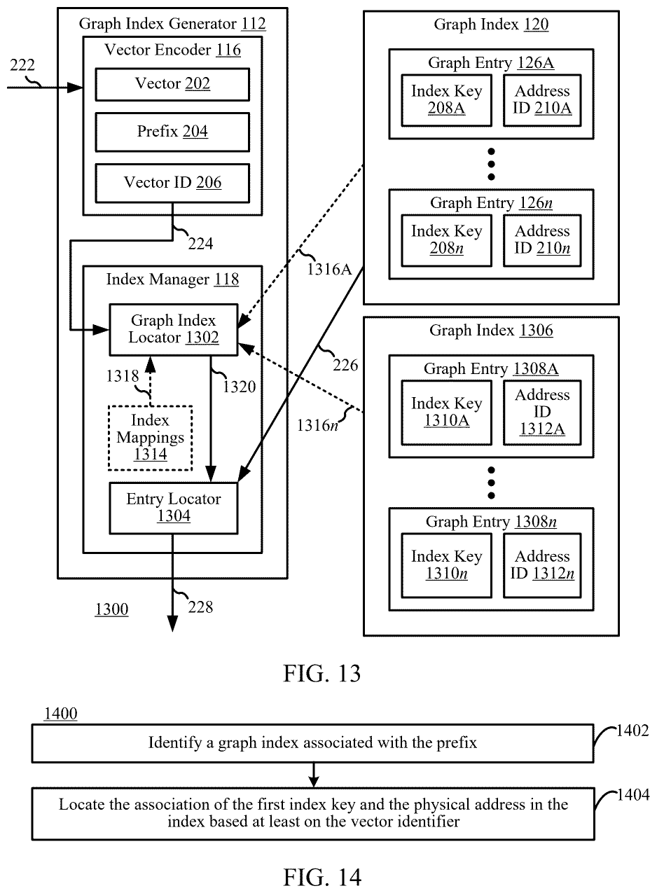

In step 1106, the first index key is associated in the index with the quantized vector identifier. For example, index manager 118 associates an index key in the index with the quantized vector identifier. In an embodiment, the index key is a different version of key than the one used for a full vector. For instance, the index key for a quantized vector includes a type identifier indicating it is a quantized vector type. In an embodiment, the association between the index key for the quantized vector and its physical storage address is stored in the same graph index as the association for the full vector (e.g., graph index 120). Alternatively, the association is stored in a separate graph index for compressed vectors. By using a separate graph index, index manager 118 can implement an efficient scan process that scans compressed vectors for retrieving quantized values in a range. In a situation where separate graph indexes are used, index manager 118 selects which index to retrieve data from based on a type indication in a search request. Additional details regarding using multiple graph indexes are described with respect to FIGS. 13 and 14, as well as elsewhere herein.

Thus, examples for storing quantized data for a vector using a graph index have been described with respect to flowchart 1100A. In some embodiments, a cache is maintained to efficiently allow access to quantized data. For instance, index manager 118 or storage manager 114 determines a frequency at which a quantized vector is accessed (such as by search requests or search algorithms). If the frequency satisfies a predetermined threshold, index manager 118 or storage manager 114 stores a copy of the quantized vector in a cache. By maintaining a cache in this manner, latency between search requests and responses thereto is reduced. This enables systems leveraging graph index 120 to handle a higher throughput of requests.

In some embodiments, graph index generator 112 of FIG. 2 supports storing vector list information. Such embodiments of graph index generator 112 operate in various ways. For example, FIG. 11B shows a flowchart 1100B of a process for indexing list information, in accordance with an example embodiment. In an embodiment, graph index generator 112 of FIG. 2 operates according to one or more steps of flowchart 1100B. Note that not all steps of flowchart 1100B need be performed in all embodiments. Further structural and operational embodiments will be apparent to persons skilled in the relevant art(s) based on the following description of FIG. 11B with respect to FIG. 2.

Flowchart 1100B begins with step 1108. In step 1108, the first vector is converted into list information. For example, vector encoder 116 of FIG. 2 in an embodiment converts vector 202 into list information. In an example, list information specifies a length of the list and vector identities within the list. In an embodiment, the vector identities in the list represent vectors adjacent to or otherwise connected to the first vector in a graph. For instance, suppose vector 202 corresponds to vertex 812 of graph 800, as described with respect to FIG. 8. In this example, list information for vertex 812 specifies the length of a list of adjacent vertices (4) and lists identities of vertices 804, 806, 810, and 816 connected to vertex 812 in graph 800. In an alternative embodiment, list information for vertex 812 includes vertex 812 in the list of adjacent vertices.

In another example, list information specifies proximity relationship between vector 202 and other vectors in vector space. For instance, in an embodiment, list information specifies other vectors in vector space within a predetermined distance to vector 202. In a further embodiment, the other vectors are listed in a ranked order from closest to furthest to vector 202 in vector space. In another further embodiment, respective distances between vector 202 and the respective other vector is included in the list information.

In step 1110, the graph is generated in accordance with the list information. For instance, with reference to graph 800 of FIG. 8, suppose graph 800 does not include vertex 812. In this context, index manager 118 of FIG. 2 inserts vertex 812 corresponding to vector 202. Index manager 118 further generates edges between vertex 812 and respective ones of vertices 804, 806, 810, and 816 based on the list information generated in step 1112. In this manner, index manager 118 can insert new data in a logical representation with respect to other data.

As described herein, graph index generator 112 supports storing data of different types. Graph index generator 112 can provide this without requiring a requesting application to specify where data of a particular type is stored. Instead, a search application can provide a vector identifier and a vector type for the vector to cause graph index generator 112 to locate and provide the data in response. Graph index generator 112 operates in various ways to enable access to data based on a type of the data. For example, FIG. 12 shows a flowchart 1200 of a process for accessing data based on a type of the data, in accordance with an example embodiment. In an embodiment, graph index generator 112 of FIG. 2 operates according to one or more steps of flowchart 1200. Note not all steps of flowchart 1200 need be performed in all embodiments. Further structural and operational embodiments will be apparent to persons skilled in the relevant art(s) based on the following description of FIG. 12 with respect to FIG. 2.

Flowchart 1200 begins with step 1202. Step 1202 is a further example of step 320 of flowchart 300B of FIG. 3B. In step 1202, a second request for data is received. For example, vector encoder 116 receives request 222 in a similar manner as described with respect to step 320.

In step 1204, a second vector representative of the requested data is determined. For example, vector encoder 116 determines a vector representative of the requested data in similar manners as described with respect to step 322. In an embodiment, the requested vector is identified in request 222. Alternatively, vector encoder 116 generates a vector representative of data in request 222 utilizing an embedding model such as embedding model 410 of FIG. 4. In an embodiment, the vector is a representation of data that graph index generator 112 is to return nearest neighbors for in a response.

In step 1206, a type of the second vector is determined from among at least a full vector type, a quantized vector type, and a list type. For example, vector encoder 116 of FIG. 2 determines a type of the vector from among at least a full vector type, a quantized vector type, and a list type. In an embodiment, the type is specified in request 222. In an alternative embodiment, vector encoder 116 of FIG. 2 automatically determines the type based on metadata of request 222. For instance, suppose request 222 is received from an application 110 and application 110 is a search engine. In this context, metadata of request 222 specifies that application 110 is requesting a list of nearest neighbors and expects a list response. In this example, the determined type is a vector list type. In another example, metadata of request 222 indicates it is a scan for quantized vectors. In this other example, the determined type is a quantized vector type.

In step 1208, at least the second vector is encoded into a request prefix, the request prefix specifying a location of the second vector in vector space and a type of the second vector. For example, vector encoder 116 encodes the second vector and the determined type into a “request prefix” that specifies a location of the second vector in vector space and its type. The request prefix is concatenated with a vector ID of the request vector to generate an index key.

In step 1210, the data is located based at least on the determined type and the prefix. For example, index manager 118 locates the data based on the determined type and prefix. In an embodiment, index manager 118 locates the data by utilizing the index key generated from the vector ID and prefix as a key in a key/value store. An example of a key/value store is shown below in Table 1.

TABLE 1
Graph Index 120 Key/Value Store Excerpt

| Key | Value |
|---|---|
| Path_Hash1 + TermType1 + VectorIDA | Version1 + FullVectorData |
| Path_Hash1 + TermType2 + VectorIDA | Version1 + QuantVectorData |
| Path_Hash1 + TermType3 + VectorIDA | Version2 + ListData |
| Path_Hash2 + TermType1 + VectorIDB | Version3 + FullVectorData |
| Path_Hash2 + TermType3 + VectorIDB | Version3 + ListData |

As shown in Table 1, “keys” are index keys that are concatenations of prefixes and vector IDs. The prefixes in Table 1 are themselves concatenations of hashes of locations of the vectors in vector space and term types. The “values” of Table 1 are vector values that correspond to respective index keys. As shown in Table 1, values are concatenations of version information and vector value data. While Table 1 shows full vector data, quant vector data, and list data in the same table, other implementations can separate different types of data into different tables. In a non-limiting example described with respect to Table 1, suppose the requested data is a quantized vector type and is requested for vector ID “VectorIDA”. In this example, index manager matches the key of the second row of Table 1 to the index key and obtains the value “Version1+QuantVectorData”. Depending on the implementation the obtained value can be the vector value (as in the example of Table 1) or it can bean address ID of a physical address at which the vector value is stored (as in an alternative example with reference to FIG. 2).

In step 1212, the data is caused to be returned as a response to the second request. For example, index manager 118 causes data obtained in step 1210 to be returned as a response to request 222. In reference to the running example described with respect to step 1210, index manager 118 causes “Version1+QuantVectorData” to be returned as a response to request 222. In a further embodiment, index manager 118 causes storage manager 114 to return “Version1+QuantVectorData” as response 232. For instance, suppose the key Path_Hash1+TermType2+VectorIDA was used in step 1210 to determine an address ID 210A of physical address 128A where Version1+QuantVectorData is stored. In this example, storage manager 114 receives information 228 from index manager 118 specifying physical address 128A stores data to be returned as a response to request 222. Storage manager 114 accesses physical address 128A to receive data 230 comprising Version1+QuantVectorData and provides a response 232 comprising data 230 as a response to request 222.

### VII. Example Embodiments Supporting Multiple Indices

Several embodiments have been described herein with respect to graph index generator 112 generating, accessing, and otherwise utilizing graph index 120. In some embodiments, graph index generator 112 generates, accesses, and/or otherwise utilizes multiple graph indexes. For instance, different graph indexes can be utilized for indexing different types of data, such as where a first graph index indexes full vector data, a second graph index indexes compressed vector data, a third graph index indexes list data, and/or the like. In another aspect, different graph indexes are used for different application types or for different domains. In either such implementation, graph index generator 112 can be configured in various ways to utilize multiple graph indexes. For example, FIG. 13 shows a block diagram of a system 1300 for locating an association in an index, in accordance with an example embodiment. As shown in FIG. 13, system 1300 comprises graph index generator 112 (comprising vector encoder 116 (comprising vector 202, prefix 204, and vector ID 206) and index manager 118) and graph index 120 (comprising graph entry 126A (including index key 208A and address ID 210A) and graph entry 126n (including index key 208n and address ID 208n)), as described with respect to FIGS. 1 and 2, as well as a graph index 1306. Graph index 1306 is a graph vector index similar to graph index 120. Depending on the implementation, graph index 1306 is associated with a different managing entity than graph index 120. Alternatively, graph index 1306 and graph index 120 are associated with the same entity but different subgroups (such as different teams, divisions, departments, and/or the like of the same organization). In another alternative, graph index 1306 and graph index 120 are associated with the same entity but store different types of data. For example, in a non-limiting example, graph index 120 stores full vector data on behalf of an entity and graph index 1306 stores quantized vector data on behalf of the same entity.

As also shown in FIG. 13, index manager 118 comprises a graph index locator 1302 and an entry locator 1304, as well as, optionally, index mappings 1314. Graph index locator 1302 and entry locator 1304 are computer-implemented subcomponents and/or subservices of index manager 118. Graph index locator 1302 is configured to locate a graph index based at least on an index key, a portion thereof, or information related to a search request or storage request. Entry locator is configured to search graph indexes for an entry based at least on the index key or a portion thereof. Index mappings 1314 comprise mappings of different identifiers or other information to respective graph indexes 120 and 1306. In certain embodiments, graph index locator 1302 utilizes index mappings 1314 to locate a graph index.

To better understand the operation of index manager 118 of system 1300, FIG. 13 is described with respect to FIG. 14. FIG. 14 shows a flowchart 1400 of a process for locating an association in an index, in accordance with an example embodiment. In an embodiment, index manager 118 of FIG. 13 operate according to one or more steps of flowchart 1400. Note not all steps of flowchart 1400 need be performed in all embodiments. In an embodiment, flowchart 1400 is a further example of step 326 of flowchart 300B as described with respect to FIG. 3B. Further structural and operational embodiments will be apparent to persons skilled in the relevant art(s) based on the following description of FIG. 14 with respect to FIG. 13.

Flowchart 1400 begins with step 1402. In an example, step 1402 is subsequent to step 324 of flowchart 300B of FIG. 3B. In step 1402, a graph index associated with the prefix is identified. For example, graph index locator 1302 of FIG. 13 identifies a graph index of at least graph indexes 120 and 1306 based on information related to request 222 and/or index key 224. Depending on the implementation, graph index locator 1302 can utilize a prefix of index key 224, a vector type of the requested vector, metadata of request 222, the hash location of the vector, and/or other information related to request 222 to identify which graph index to search for the vector value. In an aspect, graph index locator 1302 compares information with index mappings 1314 to obtain a mapping result 1318. For instance, suppose graph indexes are separated based on data type and request 222 is a request for a quantized vector type. Further suppose in this example that index mappings 1314 specifies graph index 120 stores indexes for quantized vector data and graph index 13306 stores indexes for full vector data. In this example, mapping result 1318 indicates that graph index 120 is to be used for locating the quantized vector data and graph index locator 1302 provides an indication 1320 to entry locator 1304 indicating graph index 120 is to be searched using index key 224.

In an alternative aspect, graph index locator 1302 queries or otherwise evaluates graph indexes 120 and 1306 for information. For instance, suppose graph index 120 and graph index 1306 store or otherwise indicate the data type they store. In an example, this information is included in a logical register or flag. Graph index locator 1302 receives information 1316A from graph index 120 and information 1316n from graph index 1306 indicating respective flags for the respective graphs. In this example, the flag indicates which data type the graph stores, though other types of differentiations can be used. Graph index locator 1302 determines based on information 1316A and 1316n that graph index 120 stores index information for quantized vector data and provides indication 1320 to entry locator 1304.

In step 1404, the association of the first index key and the physical address is located in the index based at least on the vector identifier. For example, entry locator 1304 of FIG. 13 receives indication 1320 and locates the association of index key 224 and a physical address in the graph index indicated in indication 1320. For instance, in the example described with respect to step 1402, entry locator 1304 utilizes index key 224 as a key to search graph index 120 for a matching entry. In a non-limiting example, index key 224 matches with index key 208A and entry locator 1304 locates the association described with respect to graph entry 126A. In an example, flow continues to step 328 of flowchart 300B of FIG. 3B.

Thus, an example embodiment supporting multiple graph indexes is described herein. In this context, systems can differentiate graph indexes from one another in order to support efficient searching. For instance, it can take index manager 118 less time to search through quantized vector index information than through full vector index information. In this example, by separating index information for quantized vectors and full vectors in separate graph indexes, searching operations with respect to quantized vectors can take less time than searching through a mixed graph index. Furthermore, if graph indexes are separated based on data types, the stored index keys can be simplified. For instance, if the entirety of graph index 120 indexes quantized vector data, then index keys 208A-208n do not need to include vector type identifiers in them, thereby reducing the space needed for the index keys.

### VIII. Example Computer System Implementation

Systems, devices, components, and/or techniques described herein are implemented in hardware, or hardware combined with one or both of software and/or firmware. For example, application 110, graph index generator 112, storage manager 114, vector encoder 116, index manager 118, graph index 120, query compilation and optimization component 32, query planning component 134, backend code generator 136, query runtime manager 138, model interface 402, prefix generator 404, index key generator 406, embedding model 410, graph 800, graph index locator 1302, entry locator 1304, and/or graph index 1306 and/or each of the components described therein, and/or the steps of flowcharts 300A, 300B, 500, 600, 700, 900, 1000, 1100A, 1100B, 1200, and/or 1500 are each implemented as computer program code/instructions configured to be executed in one or more processors and stored in a computer readable storage medium. Alternatively, graph index generator 112, storage manager 114, vector encoder 116, index manager 118, query compilation and optimization component 32, query planning component 134, backend code generator 136, query runtime manager 138, model interface 402, prefix generator 404, index key generator 406, graph index locator 1302, and/or entry locator 1304, and/or each of the components described therein, and/or the steps of flowcharts 300A, 300B, 500, 600, 700, 900, 1000, 1100A, 1100B, 1200, and/or 1500 are each implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

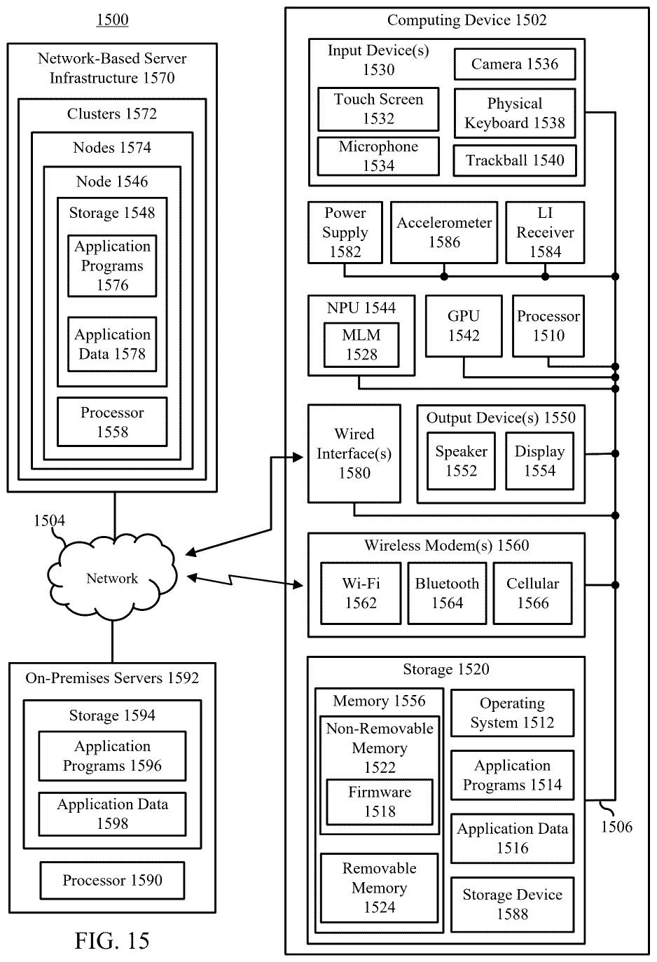

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 15. FIG. 15 shows a block diagram of an exemplary computing environment 1500 that includes a computing device 1502. Computing device 1502 is an example of computing device 102, generator server device 104, servers 106, storage 122, storage 124, and/or model server device 408, which each include one or more of the components of computing device 1502. In some embodiments, computing device 1502 is communicatively coupled with devices (not shown in FIG. 15) external to computing environment 1500 via network 1504. In accordance with an embodiment, network 1504 is an example of network 108 of FIG. 1. Network 1504 comprises one or more networks such as local area networks (LANs), wide area networks (WANs), enterprise networks, the Internet, etc. In examples, network 1504 includes one or more wired and/or wireless portions. In some examples, network 1504 additionally or alternatively includes a cellular network for cellular communications. Computing device 1502 is described in detail as follows.

Computing device 1502 can be any of a variety of types of computing devices. Examples of computing device 1502 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 1502 is a stationary computing device such as a desktop computer, a personal computer (PC), a stationary server device, a minicomputer, a mainframe, a supercomputer, etc.

As shown in FIG. 15, computing device 1502 includes a variety of hardware and software components, including a processor 1510, a storage 1520, a graphics processing unit (GPU) 1542, a neural processing unit (NPU) 1544, one or more input devices 1530, one or more output devices 1550, one or more wireless modems 1560, one or more wired interfaces 1580, a power supply 1582, a location information (LI) receiver 1584, and an accelerometer 1586. Storage 1520 includes memory 1556, which includes non-removable memory 1522 and removable memory 1524, and a storage device 1588. Storage 1520 also stores an operating system 1512, application programs 1514, and application data 1516. Wireless modem(s) 1560 include a Wi-Fi modem 1562, a Bluetooth modem 1564, and a cellular modem 1566. Output device(s) 1550 includes a speaker 1552 and a display 1554. Input device(s) 1530 includes a touch screen 1532, a microphone 1534, a camera 1536, a physical keyboard 1538, and a trackball 1540. Not all components of computing device 1502 shown in FIG. 15 are present in all embodiments, additional components not shown may be present, and in a particular embodiment any combination of the components are present. In examples, components of computing device 1502 are mounted to a circuit card (e.g., a motherboard) of computing device 1502, integrated in a housing of computing device 1502, or otherwise included in computing device 1502. The components of computing device 1502 are described as follows.

In embodiments, a single processor 1510 (e.g., central processing unit (CPU), microcontroller, a microprocessor, signal processor, ASIC (application specific integrated circuit), and/or other physical hardware processor circuit) or multiple processors 1510 are present in computing device 1502 for performing such tasks as program execution, signal coding, data processing, input/output processing, power control, and/or other functions. In examples, processor 1510 is a single-core or multi-core processor, and each processor core is single-threaded or multithreaded (to provide multiple threads of execution concurrently). Processor 1510 is configured to execute program code stored in a computer readable medium, such as program code of operating system 1512 and application programs 1514 stored in storage 1520. The program code is structured to cause processor 1510 to perform operations, including the processes/methods disclosed herein. Operating system 1512 controls the allocation and usage of the components of computing device 1502 and provides support for one or more application programs 1514 (also referred to as “applications” or “apps”). In examples, application programs 1514 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 1510 includes one or more general processors (e.g., CPUs) configured with or coupled to one or more hardware accelerators, such as one or more NPUs 1544 and/or one or more GPUs 1542.

Any component in computing device 1502 can communicate with any other component according to function, although not all connections are shown for ease of illustration. For instance, as shown in FIG. 15, bus 1006 is a multiple signal line communication medium (e.g., conductive traces in silicon, metal traces along a motherboard, wires, etc.) present to communicatively couple processor 1510 to various other components of computing device 1502, although in other embodiments, an alternative bus, further buses, and/or one or more individual signal lines is/are present to communicatively couple components. Bus 1006 represents one or more of any of several types of bus structures, including a memory bus or memory controller, a peripheral bus, an accelerated graphics port, and a processor or local bus using any of a variety of bus architectures.

Storage 1520 is physical storage that includes one or both of memory 1556 and storage device 1588, which store operating system 1512, application programs 1514, and application data 1516 according to any distribution. In an embodiment, storage 1520 is an example of storage 122 and/or storage 124 of FIG. 1. Non-removable memory 1522 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 1522 includes main memory and is separate from or fabricated in a same integrated circuit as processor 1510. As shown in FIG. 15, non-removable memory 1522 stores firmware 1518 that is present to provide low-level control of hardware. Examples of firmware 1518 include BIOS (Basic Input/Output System, such as on personal computers) and boot firmware (e.g., on smart phones). In examples, removable memory 1524 is inserted into a receptacle of or is otherwise coupled to computing device 1502 and can be removed by a user from computing device 1502. Removable memory 1524 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 1588 are present that are internal and/or external to a housing of computing device 1502 and are or are not removable. Examples of storage device 1588 include a hard disk drive, an SSD, a thumb drive (e.g., a USB (Universal Serial Bus) flash drive), or other physical storage device.

One or more programs are stored in storage 1520. Such programs include operating system 1512, one or more application programs 1514, and other program modules and program data. Examples of such application programs include computer program logic (e.g., computer program code/instructions) for implementing application 110, graph index generator 112, storage manager 114, vector encoder 116, index manager 118, graph index 120, query compilation and optimization component 32, query planning component 134, backend code generator 136, query runtime manager 138, model interface 402, prefix generator 404, index key generator 406, embedding model 410, graph 800, graph index locator 1302, entry locator 1304, and/or graph index 1306 and/or each of the components described therein, and/or the steps of flowcharts 300A, 300B, 500, 600, 700, 900, 1000, 1100A, 1100B, 1200, and/or 1500, and/or any individual steps thereof.

Storage 1520 also stores data used and/or generated by operating system 1512 and application programs 1514 as application data 1516. Examples of application data 1516 include web pages, text, images, tables, sound files, video data, and other data. In examples, application data 1516 is sent to and/or received from one or more network servers or other devices via one or more wired or wireless networks. Storage 1520 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 1502 through one or more input devices 1530 and receives information from computing device 1502 through one or more output devices 1550. Input device(s) 1530 includes one or more of touch screen 1532, microphone 1534, camera 1536, physical keyboard 1538 and/or trackball 1540 and output device(s) 1550 includes one or more of speaker 1552 and display 1554. Each of input device(s) 1530 and output device(s) 1550 are integral to computing device 1502 (e.g., built into a housing of computing device 1502) or are external to computing device 1502 (e.g., communicatively coupled wired or wirelessly to computing device 1502 via wired interface(s) 1580 and/or wireless modem(s) 1560). Further input devices 1530 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1554 displays information, as well as operating as touch screen 1532 by receiving user commands and/or other information (e.g., by touch, finger gestures, virtual keyboard, etc.) as a user interface. Any number of each type of input device(s) 1530 and output device(s) 1550 are present, including multiple microphones 1534, multiple cameras 1536, multiple speakers 1552, and/or multiple displays 1554.

In embodiments where GPU 1542 is present, GPU 1542 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 1542 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 1544 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 1528. In an example, NPU 1544 is configured for a data-driven parallel computing and is highly efficient at processing massive multimedia data such as videos and images and processing data for neural networks. NPU 1544 is configured for efficient handling of AI-related tasks, such as speech recognition, background blurring in video calls, photo or video editing processes like object detection, etc.

In embodiments disclosed herein that implement ML models, NPU 1544 can be utilized to execute such ML models, of which MLM 1528 is an example. In an embodiment, MLM 1528 is an example of embedding model 410 of FIG. 4. For instance, where applicable, MLM 1528 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 1544 is used to train MLM 1528. To train MLM 1528, training data that includes input features (attributes) and their corresponding output labels/target values (e.g., for supervised learning) is collected. A training algorithm is a computational procedure that is used so that MLM 1528 learns from the training data. Parameters/weights are internal settings of MLM 1528 that are adjusted during training by the training algorithm to reduce a difference between predictions by MLM 1528 and actual outcomes (e.g., output labels). In some examples, MLM 1528 is set with initial values for the parameters/weights. A loss function measures a dissimilarity between predictions by MLM 1528 and the target values, and the parameters/weights of MLM 1528 are adjusted to minimize the loss function. The parameters/weights are iteratively adjusted by an optimization technique, such as gradient descent. In this manner, MLM 1528 is generated through training by NPU 1544 to be used to generate inferences based on received input feature sets for particular applications. MLM 1528 is generated as a computer program or other type of algorithm configured to generate an output (e.g., a classification, a prediction/inference) based on received input features, and is stored in the form of a file or other data structure.

In examples, such training of MLM 1528 by NPU 1544 is supervised or unsupervised. According to supervised learning, input objects (e.g., a vector of predictor variables) and a desired output value (e.g., a human-labeled supervisory signal) train MLM 1528. The training data is processed, building a function that maps new data on expected output values. Example algorithms usable by NPU 1544 to perform supervised training of MLM 1528 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 1528 is an LLM, MLM 1528 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 1528 is trained to learn patterns from unlabeled data. For instance, in embodiments where MLM 1528 implements unsupervised learning techniques, MLM 1528 identifies one or more classifications or clusters to which an input belongs. During a training phase of MLM 1528 according to unsupervised learning, MLM 1528 tries to mimic the provided training data and uses the error in its mimicked output to correct itself (i.e., correct weights and biases). In further examples, NPU 1544 perform unsupervised training of MLM 1528 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 1544 need not necessarily be present in all ML model embodiments. In embodiments where ML models are present, any one or more of processor 1510, GPU 1542, and/or NPU 1544 can be present to train and/or execute MLM 1528.

One or more wireless modems 1560 can be coupled to antenna(s) (not shown) of computing device 1502 and can support two-way communications between processor 1510 and devices external to computing device 1502 through network 1504, as would be understood to persons skilled in the relevant art(s). Wireless modem 1560 is shown generically and can include a cellular modem 1566 for communicating with one or more cellular networks, such as a GSM network for data and voice communications within a single cellular network, between cellular networks, or between the mobile device and a public switched telephone network (PSTN). In examples, wireless modem 1560 also or alternatively includes other radio-based modem types, such as a Bluetooth modem 1564 (also referred to as a “Bluetooth device”) and/or Wi-Fi modem 1562 (also referred to as an “wireless adaptor”). Wi-Fi modem 1562 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1564 is configured to communicate with another Bluetooth-capable device according to the Bluetooth short-range wireless technology standard(s) such as IEEE 802.15.1 and/or managed by the Bluetooth Special Interest Group (SIG).

Computing device 1502 can further include power supply 1582, LI receiver 1584, accelerometer 1586, and/or one or more wired interfaces 1580. Example wired interfaces 1580 include a USB port, IEEE 1394 (FireWire) port, a RS-152 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 1580 of computing device 1502 provide for wired connections between computing device 1502 and network 1504, or between computing device 1502 and one or more devices/peripherals when such devices/peripherals are external to computing device 1502 (e.g., a pointing device, display 1554, speaker 1552, camera 1536, physical keyboard 1538, etc.). Power supply 1582 is configured to supply power to each of the components of computing device 1502 and receives power from a battery internal to computing device 1502, and/or from a power cord plugged into a power port of computing device 1502 (e.g., a USB port, an A/C power port). LI receiver 1584 is useable for location determination of computing device 1502 and in examples includes a satellite navigation receiver such as a Global Positioning System (GPS) receiver and/or includes other type of location determiner configured to determine location of computing device 1502 based on received information (e.g., using cell tower triangulation, etc.). Accelerometer 1586, when present, is configured to determine an orientation of computing device 1502.

Note that the illustrated components of computing device 1502 are not required or all-inclusive, and fewer or greater numbers of components can be present as would be recognized by one skilled in the art. In examples, computing device 1502 includes one or more of a gyroscope, barometer, proximity sensor, ambient light sensor, digital compass, etc. In an example, processor 1510 and memory 1556 are co-located in a same semiconductor device package, such as being included together in an integrated circuit chip, FPGA, or system-on-chip (SOC), optionally along with further components of computing device 1502.

In embodiments, computing device 1502 is configured to implement any of the above-described features of flowcharts herein. Computer program logic for performing any of the operations, steps, and/or functions described herein is stored in storage 1520 and executed by processor 1510.

In some embodiments, server infrastructure 1570 is present in computing environment 1500 and is communicatively coupled with computing device 1502 via network 1504. Server infrastructure 1570, when present, is a network-accessible server set (e.g., a cloud-based environment or platform). As shown in FIG. 15, server infrastructure 1570 includes clusters 1572. Each of clusters 1572 comprises a group of one or more compute nodes and/or a group of one or more storage nodes. For example, as shown in FIG. 15, cluster 1572 includes nodes 1574. Each of nodes 1574 are accessible via network 1504 (e.g., in a “cloud-based” embodiment) to build, deploy, and manage applications and services. In examples, any of nodes 1574 is a storage node that comprises a plurality of physical storage disks, SSDs, and/or other physical storage devices that are accessible via network 1504 and are configured to store data associated with the applications and services managed by nodes 1574.

Each of nodes 1574, as a compute node, comprises one or more server computers, server systems, and/or computing devices. For instance, a node 1574 in accordance with an embodiment includes one or more of the components of computing device 1502 disclosed herein. Each of nodes 1574 is configured to execute one or more software applications (or “applications”) and/or services and/or manage hardware resources (e.g., processors, memory, etc.), which are utilized by users (e.g., customers) of the network-accessible server set. In examples, as shown in FIG. 15, nodes 1574 includes a node 1546 that includes storage 1548 and/or one or more of a processor 1558 (e.g., similar to processor 1510, GPU 1542, and/or NPU 1544 of computing device 1502). Storage 1548 stores application programs 1576 and application data 1578. Processor(s) 1558 operate application programs 1576 which access and/or generate related application data 1578. In an implementation, nodes such as node 1546 of nodes 1574 operate or comprise one or more virtual machines, with each virtual machine emulating a system architecture (e.g., an operating system), in an isolated manner, upon which applications such as application programs 1576 are executed.

In embodiments, one or more of clusters 1572 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 1572 are included in a datacenter in a distributed collection of datacenters. In embodiments, exemplary computing environment 1500 comprises part of a cloud-based platform.

In an embodiment, computing device 1502 accesses application programs 1576 for execution in any manner, such as by a client application and/or a browser at computing device 1502.

In an example, for purposes of network (e.g., cloud) backup and data security, computing device 1502 additionally and/or alternatively synchronizes copies of application programs 1514 and/or application data 1516 to be stored at network-based server infrastructure 1570 as application programs 1576 and/or application data 1578. In examples, operating system 1512 and/or application programs 1514 include a file hosting service client configured to synchronize applications and/or data stored in storage 1520 at network-based server infrastructure 1570.

In some embodiments, on-premises servers 1592 are present in computing environment 1500 and are communicatively coupled with computing device 1502 via network 1504. On-premises servers 1592, when present, are hosted within an organization's infrastructure and, in many cases, physically onsite of a facility of that organization. On-premises servers 1592 are controlled, administered, and maintained by IT (Information Technology) personnel of the organization or an IT partner to the organization. Application data 1598 can be shared by on-premises servers 1592 between computing devices of the organization, including computing device 1502 (when part of an organization) through a local network of the organization, and/or through further networks accessible to the organization (including the Internet). Furthermore, in examples, on-premises servers 1592 serve applications such as application programs 1596 to the computing devices of the organization, including computing device 1502. Accordingly, in examples, on-premises servers 1592 include storage 1594 (which includes one or more physical storage devices such as storage disks and/or SSDs) for storage of application programs 1596 and application data 1598 and include a processor 1590 (e.g., similar to processor 1510, GPU 1542, and/or NPU 1544 of computing device 1502) for execution of application programs 1596. In some embodiments, multiple processors 1590 are present for execution of application programs 1596 and/or for other purposes. In further examples, computing device 1502 is configured to synchronize copies of application programs 1514 and/or application data 1516 for backup storage at on-premises servers 1592 as application programs 1596 and/or application data 1598.

Embodiments described herein may be implemented in one or more of computing device 1502, network-based server infrastructure 1570, and on-premises servers 1592. For example, in some embodiments, computing device 1502 is used to implement systems, clients, or devices, or components/subcomponents thereof, disclosed elsewhere herein. In other embodiments, a combination of computing device 1502, network-based server infrastructure 1570, and/or on-premises servers 1592 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1520. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1514) are stored in storage 1520. Such computer programs can also be received via wired interface(s) 1560 and/or wireless modem(s) 1560 over network 1504. Such computer programs, when executed or loaded by an application, enable computing device 1502 to implement features of embodiments discussed herein. Accordingly, such computer programs represent controllers of the computing device 1502.

Embodiments are also directed to computer program products comprising computer code or instructions stored on any computer-readable medium or computer-readable storage medium. Such computer program products include the physical storage of storage 1520 as well as further physical storage types.

### IX. Additional Exemplary Embodiments

A method is described herein. The method comprises: receiving a first request to store first data in a dataset; encoding at least the first data into a first prefix; generating a first index key from the first prefix; associating, in an index corresponding to at least a portion of the first index key, the first index key with a value of the first data.

In a further aspect of the forgoing method, the first data is a first vector.

In a further aspect of the forgoing method, the prefix specifies a location of the first vector in vector space.

In a further aspect of the forgoing method, the prefix specifies a type of the first vector.

In a further aspect of the forgoing method, the method further comprises, assigning a first vector identifier to the first vector.

In a further aspect of the forgoing method, said generating the first index key is further based on the first vector identifier.

In a further aspect of the forgoing method, said associating the first index key with the value of the first data comprises associating, in the index, the first index key with a physical address associated with the dataset.

In a further aspect of the forgoing method, the method further comprises: storing the first data at the physical address.

In a further aspect of the forgoing method, said encoding the first data into a first prefix comprises: determining a first vector representative of the first data; and encoding at least the first vector into the first prefix.

In a further aspect of the forgoing method, said encoding further comprises: generating a hash of the location of the first vector; and concatenating the hash and a type identifier of the type of the first vector, the concatenated hash and type identifier being the first prefix.

In a further aspect of the forgoing method, the method further comprises: receiving a second request for data; generating a second index key based at least on the second request; utilizing the second index key to locate the association between the first index key and the value of the first data in the index; and causing the value of the first data to be provided as a response to the second request.

In a further aspect of the forgoing method, wherein the second request is a second request for vector data.

In a further aspect of the forgoing method, said utilizing the second index key to locate the association further comprises: determining a level of semantic similarity between the first index key and the second index key satisfies a predetermined threshold.

In a further aspect of the forgoing method, wherein the second request comprises a second vector and said generating the second index key comprises: encoding the second vector into a second prefix, the second prefix specifying a location of the second vector in vector space; assigning a second vector identifier to the second vector; and generating the second index key from the second prefix and the second vector identifier.

In a further aspect of the forgoing method, said utilizing the second index key to locate the association comprises: determining the second index key matches the first index key.

In a further aspect of the forgoing method, said associating the first index key with a value of the first vector in the index comprises: associating the first index key with a physical address of a memory device storing the value of the first vector.

In a further aspect of the forgoing method, the index is a graph comprising: a first vertex corresponding to the first vector; a second vertex corresponding to a second vector; and an edge connecting the first vertex to the second vertex, the edge indicating a dependency of the first vertex on the second vertex.

In a further aspect of the forgoing method, the method further comprises: receiving a second request for data; generating a second index key based at least on the second request; and traversing the graph to locate the first vertex.

In a further aspect of the forgoing method, the method further comprises: identifying a root vertex of the graph based at least on the second request.

In a further aspect of the forgoing method, said traversing the graph comprises: beginning at a root vertex of the graph, traversing to the second vertex, and identifying the first vertex based at least on the edge.

In a further aspect of the forgoing method, traversing to the second vertex comprises greedily selecting a subsequent vertex based on a level of similarity between the subsequent vertex and the second index key satisfying a similarity threshold.

In a further aspect of the forgoing method, traversing the graph comprises, responsive to determining the level of similarity between the subsequent vertex and the second index key satisfies the similarity threshold, determining a second subsequent vertex identifier of the second subsequent vertex of the graph.

In a further aspect of the forgoing method, the second request is a request for vector data stored responsive to the first request.

In a further aspect of the forgoing method, the type of the first vector is an adjacency vector list type.

In a further aspect of the forgoing method, said associating the first index with the physical address comprises: determining, based at least on the first index key, a storage system from among a plurality of storage systems, the storage system comprising the physical address; determine a schema of the storage system; and map the first index with the physical address in accordance with the schema.

In a further aspect of the forgoing method, the method further comprising: compressing the first vector into a first quantized vector; assigning a quantized vector identifier to the quantized vector; and associating, in the index, the first index key with the quantized vector identifier.

In a further aspect of the forgoing method, the method further comprises: identifying a graph index associated with the prefix; and locating the association of the first index key and the physical address in the index based at least on the vector identifier.

In a further aspect of the forgoing method, the method further comprises: receiving a second request for data; determining a second vector representative of the requested data; determining the type of second vector from among a full vector type, a quantized vector type, or a list type; encoding at least the second vector into a request prefix; locating the data based at least on the determined type and the prefix; causing the data to be returned as a response to the second request.

In a further aspect of the forgoing method, the method further comprises: receiving a second request for data; determining a second vector based on the second request; generating a second index key based at least on the second vector; determining a level of similarity between the first index key and the second key satisfies a threshold; and returning at least the first data as a response to the second request.

In a further aspect of the forgoing method, said determining the level of similarity between the second index key and the first index key satisfies the threshold comprises: determining the first index key is a near neighbor to the second index key in a graph.

In a further aspect of the forgoing method, said determining the level of similarity between the second index key and the first index key satisfies the threshold comprises: determining the second index key is identical to the first index key.

In a further aspect of the forgoing method, wherein the second request for data is a request for nearest neighbors to data in the second request.

A system comprising a processor and memory is described herein. The memory storing program code is structured to cause the processor to perform any of the foregoing methods.

A computer-readable storage medium encoded with program instructions that, when executed by a processor circuit, perform any of the foregoing methods described herein.

### X. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Further still, example embodiments have been described with respect to non-relational databases; however, it is also contemplated herein that some embodiments can be implemented with respect to relational databases (such as a SQL database).

Moreover, according to the described embodiments and techniques, any components of systems, computing devices, servers, applications, graph index generators, storage managers, graph indexes, embedding models, and/or their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

1. A system comprising:
a processor; and
a memory that stores program code structured to cause the processor to:
receive a first request to store first data in a dataset;
generate a first vector representative of the first data;
convert the first vector into a first prefix by encoding the first vector into a representation specifying a location of the first vector in vector space and a type of the first vector;
assign a first vector identifier to the first vector;
generate a first index key based on the first prefix and the first vector identifier;
associate, in an index, the first index key with a physical address associated with the dataset; and
store the first data at the physical address.

2. The system of claim 1, wherein the program code is further structured to cause the processor to:
receive a second request for second data;
generate a second index key based at least on the second request;
utilize the second index key to locate the association between the first index key and the physical address in the index; and
cause the first data to be provided as a response to the second request.

3. The system of claim 1, wherein to convert the first vector into the first prefix, the program code is further structured to cause the processor to:
generate a hash of the location of the first vector; and
concatenate the hash and a type identifier of the type of the first vector, the concatenated hash and type identifier being the first prefix.

4. The system of claim 1, wherein the index is a graph comprising:
a first vertex corresponding to the first vector;
a second vertex corresponding to a second vector; and
an edge connecting the first vertex to the second vertex, the edge indicating a dependency of the first vertex on the second vertex.

5. The system of claim 4, wherein the program code is further structured to cause the processor to:
receive a second request for the first data;
generate the first index key based at least on the second request;
identify a root vertex of the graph based at least on the second request; and
traverse the graph from the root vertex to locate the first vertex.

6. The system of claim 5, wherein to identify the root vertex, the program code is further structured to cause the processor to:
identify the root vertex based at least on the first prefix of the first index key; and
to traverse the graph, the program code is further structured to cause the processor to:
determine, based at least on the root vertex, a first subsequent vertex identifier of a first subsequent vertex of the graph,
utilize a key-value store to determine a vertex value corresponding to the first subsequent vertex identifier,
determine a level of similarity between the vertex value and the first vertex satisfies a threshold,
responsive to determining the level of similarity satisfies the threshold, determine, based at least on the vertex value, a second subsequent vertex identifier of a second subsequent vertex of the graph, and
continue traversing the graph until the first vertex is identified.

7. The system of claim 1, wherein to associate the first index with the physical address, the program code is further structured to:
determine, based at least on the first index key, a storage system from among a plurality of storage systems, the storage system comprising the physical address;
determine a schema of the storage system; and
map the first index with the physical address in accordance with the schema.

8. The system of claim 1, wherein the program code is further structured to cause the processor to:
compress the first vector into a first quantized vector;
assign a quantized vector identifier to the quantized vector; and
associate, in the index, the first index key with the quantized vector identifier.

9. A computer-implemented method comprising:
receiving a first request to store a first vector in a dataset;
converting at least the first vector into a first prefix by encoding the first vector into a representation specifying a location of the first vector in vector space;
assigning a first vector identifier to the first vector;
generating a first index key from the first prefix and the first vector identifier;
associating, in an index corresponding to at least a portion of the first index key, the first index key with a value of the first vector.

10. The computer-implemented method of claim 9, further comprising:
receiving a second request for vector data;
generating a second index key based at least on the second request;
utilizing the second index key to locate the association between the first index key and the value of the first vector in the index; and
causing the value of the first vector to be provided as a response to the second request.

11. The computer-implemented method of claim 10, wherein said utilizing the second index key to locate the association further comprises:
determining a level of semantic similarity between the first index key and the second index key satisfies a predetermined threshold.

12. The computer-implemented method of claim 10, wherein the second request comprises a second vector and said generating the second index key comprises:
encoding the second vector into a second prefix, the second prefix specifying a location of the second vector in vector space;
assigning a second vector identifier to the second vector; and
generating the second index key from the second prefix and the second vector identifier.

13. The computer-implemented method of claim 12, wherein said utilizing the second index key to locate the association comprises:
determining the second index key matches the first index key.

14. The computer-implemented method of claim 9, wherein said associating the first index key with a value of the first vector in the index comprises:
associating the first index key with a physical address of a memory device storing the value of the first vector.

15. The computer-implemented method of claim 9, wherein the index is a graph comprising:
a first vertex corresponding to the first vector;
a second vertex corresponding to a second vector; and
an edge connecting the first vertex to the second vertex, the edge indicating a dependency of the first vertex on the second vertex.

16. The computer-implemented method of claim 15, further comprising:
receiving a second request for vector data;
generating a second index key based at least on the second request; and
traversing the graph to locate the first vertex by:
beginning at a root vertex of the graph,
traversing to the second vertex by greedily selecting a subsequent vertex based on a level of similarity between the subsequent vertex and the second index key satisfying a similarity threshold, and
identifying the first vertex based at least on the edge.

17. The computer-implemented method of claim 9, wherein the type of the first vector is an adjacency vector list type.

18. A computer-readable storage medium with program instructions encoded thereon, the program instructions structured to cause a processor to perform a method, the method comprising:
receiving a first request to store a first vector in a dataset;
converting at least the first vector into a first prefix by encoding the first vector into a representation specifying a location of the first vector in vector space;
assigning a first vector identifier to the first vector;
generating a first index key from the first prefix and the first vector identifier;
associating, in an index corresponding to at least a portion of the first index key, the first index key with a value of the first vector.

19. The computer-readable storage medium of claim 18, the method further comprising:
receiving a second request for vector data;
generating a second index key based at least on the second request;
utilizing the second index key to locate the association between the first index key and the value of the first vector in the index; and
causing the value of the first vector to be provided as a response to the second request.

20. The computer-readable storage medium of claim 19, wherein
the index is a graph comprising:
a first vertex corresponding to the first vector,
a second vertex corresponding to a second vector, and
an edge connecting the first vertex to the second vertex, the edge indicating a dependency of the first vertex on the second vertex; and
the method further comprises:
receiving a second request for vector data,
generating a second index key based at least on the second request; and
traversing the graph to locate the first vertex by:
beginning at a root vertex of the graph,
traversing to the second vertex by greedily selecting a subsequent vertex based on a level of similarity between the subsequent vertex and the second index key satisfying a similarity threshold, and
identifying the first vertex based at least on the edge.
